(19) United States
(12) Patent Application Publication
(10) Pub. No.: US 2022/0222451 A1
(43) Pub. Date: Jul. 14, 2022

(54) AUDIO PROCESSING APPARATUS, METHOD FOR PRODUCING CORPUS OF AUDIO PAIR, AND STORAGE MEDIUM ON WHICH PROGRAM IS STORED

(71) Applicant: ABELON Inc., Tokyo (JP)

(72) Inventor: Jungbum Shin, Tokyo (JP)

(21) Appl. No.: 17/615,542

(22) PCT Filed: Jan. 6, 2020
(86) PCT No.: PCT/JP2020/000057

§ 371 Date: Nov. 30, 2021

(30) Foreign Application Priority Data
May 31, 2019 (JP) 2019-102417

(51) Int. Cl. G06F 40/58; G10L 15/04; G10L 15/22; G10L 15/00

(52) U.S. Cl. CPC G06F 40/58; G10L 15/005; G10L 15/22; G10L 15/04

(57) ABSTRACT

In order to solve a conventional problem that there has been no mechanism for accumulating first audio and second audio, which is audio obtained through simultaneous interpretation of the first audio, in association with each other, an audio processing apparatus includes: a first audio accepting unit that accepts first audio of speech uttered by a first speaker of a first language; a second audio accepting unit that accepts second audio, which is audio obtained through simultaneous interpretation of the first audio into a second language by a second speaker; and an accumulating unit that accumulates the first audio and the second audio in association with each other. Accordingly, it is possible to realize a mechanism for accumulating first audio and second audio, which is audio obtained through simultaneous interpretation of the first audio, in association with each other.

### TECHNICAL FIELD

The present invention relates to an audio processing apparatus and the like for processing audio of simultaneous interpretation.

### BACKGROUND ART

Conventionally, there have been remote simultaneous interpretation systems in which a simultaneous interpreter performs simultaneous interpretation at a simultaneous interpretation center remote from the place, and simultaneous interpretation voice can be sent to the place (see Patent Document 1, for example).

### CITATION LIST

### Patent Documents

Patent Document 1: JP 2007-306420A

### SUMMARY OF INVENTION

### Technical Problems

### First Problem

However, conventionally, there has been no mechanism for accumulating first audio and second audio, which is audio obtained through simultaneous interpretation of the first audio, in association with each other.

### Second Problem

Furthermore, conventionally, there has been no mechanism for properly setting an interpretation language of each of one or more interpreters and a language of a speaker corresponding to an interpreter.

### Solutions to Problems

### Solution to First Problem

A first aspect of the present invention is directed to an audio processing apparatus including: a first audio accepting unit that accepts first audio of speech uttered by a first speaker of a first language; a second audio accepting unit that accepts second audio, which is audio obtained through simultaneous interpretation of the first audio into a second language by a second speaker; and an accumulating unit that accumulates the first audio and the second audio in association with each other.

With this configuration, it is possible to accumulate first audio and second audio, which is audio obtained through simultaneous interpretation of the first audio, in association with each other.

Furthermore, a second aspect of the present invention is directed to the audio processing apparatus according to the first aspect, further including an audio association processing unit that associates a first audio segment, which is part of the first audio, with a second audio segment, which is part of the second audio, wherein the accumulating unit accumulates the first audio segment and the second audio segment associated with each other by the audio association processing unit.

With this configuration, it is possible to accumulate a portion of first audio and a portion of second audio in association with each other.

Furthermore, a third aspect of the present invention is directed to the audio processing apparatus according to the second aspect, further including a speech recognition unit that performs speech recognition processing on the first audio, thereby acquiring a first sentence block, which is text corresponding to the first audio, and performs speech recognition processing on the second audio, thereby acquiring a second sentence block, which is text corresponding to the second audio, wherein the audio association processing unit includes: a dividing part that divides the first sentence block into two or more sentences, thereby acquiring two or more first sentences, and divides the second sentence block into two or more sentences, thereby acquiring two or more second sentences; a sentence associating part that associates one or more first sentences and one or more second sentences acquired by the dividing part, with each other; and an audio associating part that associates one or more first audio segments corresponding to the one or more first sentences associated by the sentence associating part with one or more second audio segments corresponding to the one or more second sentences associated by the sentence associating part, and the accumulating unit accumulates the one or more first audio segments and the one or more second audio segments associated with each other by the audio association processing unit.

With this configuration, it is possible to accumulate a first sentence block obtained through speech recognition of first audio and a second sentence block obtained through speech recognition of second audio, in association with each other.

Furthermore, a fourth aspect of the present invention is directed to the audio processing apparatus according to the third aspect, wherein the sentence associating part includes: a machine translation part that performs machine translation of two or more first sentences acquired by the dividing part into a second language, or performs machine translation of two or more second sentences acquired by the dividing part; and a translation result associating part that compares a translation result of two or more first sentences machine-translated by the machine translation part and two or more second sentences acquired by the dividing part and associates one or more first sentences and one or more second sentences acquired by the dividing part, with each other, or compares a translation result of two or more second sentences machine-translated by the machine translation part and two or more first sentences acquired by the dividing part and associates one or more first sentences and one or more second sentences acquired by the dividing part, with each other.

With this configuration, it is possible to accumulate a first sentence and a machine translation result of the first sentence in association with each other.

Furthermore, a fifth aspect of the present invention is directed to the audio processing apparatus according to the third or fourth aspect, wherein the sentence associating part associates one first sentence and two or more second sentences acquired by the dividing part, with each other.

With this configuration, it is possible to accumulate one first sentence and two or more second sentences in association with each other.

Furthermore, a sixth aspect of the present invention is directed to the audio processing apparatus according to the fifth aspect, wherein the sentence associating part detects a second sentence corresponding to each of one or more first sentences acquired by the dividing part, and associates a second sentence not associated with the first sentence, with a first sentence corresponding to a second sentence located before the second sentence, thereby associating one first sentence with two or more second sentences.

With this configuration, it is possible to properly associate one first sentence with two or more second sentences, by associating a second sentence not associated with the first sentence, with a first sentence corresponding to a second sentence located therebefore.

Furthermore, a seventh aspect of the present invention is directed to the audio processing apparatus according to the sixth aspect, wherein the sentence associating part determines whether or not a second sentence is not associated with the first sentence and has a predetermined relationship with a second sentence located immediately therebefore, and, in a case of determining that the second sentence has a predetermined relationship therewith, associates the second sentence not associated with the first sentence, with a first sentence corresponding to the second sentence located before the second sentence.

With this configuration, even when a second sentence is not associated with the first sentence, the second sentence is not associated with a first sentence corresponding to a second sentence located immediately therebefore if it does not have the relationship with that second sentence located immediately therebefore, and thus it is possible to more properly associate one first sentence with two or more second sentences.

Furthermore, an eighth aspect of the present invention is directed to the audio processing apparatus according to the third or fourth aspect, wherein the sentence associating part detects a second sentence associated with each of two or more first sentences acquired by the dividing part, and detects a first sentence not associated with any second sentence, and the audio processing apparatus further includes a missing interpretation output unit that outputs a detection result of the sentence associating part.

With this configuration, it is possible to detect a first sentence not associated with any second sentence, and to see that there is missing interpretation based on output of a detection result.

Furthermore, a ninth aspect of the present invention is directed to the audio processing apparatus according to any one of the third to eighth aspects, further including: an evaluation acquiring unit that acquires evaluation information regarding evaluation of an interpreter who performed simultaneous interpretation, using an association result of one or more first sentences and one or more second sentences acquired by the sentence associating part; and an evaluation output unit that outputs the evaluation information.

With this configuration, it is possible to evaluate an interpreter based on association between a first sentence and a second sentence.

Furthermore, a tenth aspect of the present invention is directed to the audio processing apparatus according to the ninth aspect, wherein the evaluation acquiring unit acquires evaluation information in which the larger the number of first sentences each associated with two or more second sentences, the higher the rating.

With this configuration, it is possible to perform proper evaluation, by giving a higher rating to an interpreter whose interpretation has a larger number of supplements.

Furthermore, an eleventh aspect of the present invention is directed to the audio processing apparatus according to the ninth or tenth aspect, wherein the evaluation acquiring unit acquires evaluation information in which the smaller the number of first sentences not associated with any second sentence, the lower the rating.

With this configuration, it is possible to perform proper evaluation, by giving a lower rating to an interpreter whose interpretation has a larger number of missing parts.

Furthermore, a twelfth aspect of the present invention is directed to the audio processing apparatus according to any one of the ninth to eleventh aspects, wherein the first audio and the second audio are associated with timing information for specifying timing, and the evaluation acquiring unit acquires evaluation information in which the larger a difference between first timing information associated with a first sentence associated by the sentence associating part and second timing information associated with a second sentence associated with the first sentence, the lower the rating.

With this configuration, it is possible to perform proper evaluation, by giving a lower rating to an interpreter whose interpretation has a longer delay.

Furthermore, a thirteenth aspect of the present invention is directed to the audio processing apparatus according to any one of the third to twelfth aspects, wherein the audio association processing unit further includes: a timing information acquiring part that acquires two or more pieces of first timing information associated with the two or more first sentences and two or more pieces of second timing information associated with the two or more second sentences; and a timing information associating part that associates the two or more pieces of first timing information with the two or more first sentences, and associates the two or more pieces of second timing information with the two or more second sentences.

With this configuration, it is possible to accumulate two or more first sentences in association with two or more pieces of first timing information, and two or more second sentences corresponding to the two or more first sentences in association with two or more pieces of second timing information. Accordingly, it is possible to, for example, evaluate an interpreter, using a delay between a first sentence and a second sentence corresponding to each other.

### Solution to Second Problem

A first aspect of the present invention is directed to a server apparatus including: a storage unit in which one or at least two pairs of interpretation language information indicating an interpretation language representing a type regarding a language of interpretation performed by an interpreter, and a set of a first language identifier for identifying a first language that is listened to by the interpreter and a second language identifier for identifying a second language that is spoken by the interpreter are stored; a receiving unit that receives a setting result having a speaker identifier for identifying a speaker subjected to interpretation by an interpreter, based on an interpreter apparatus serving as a terminal apparatus of the interpreter, and interpretation language information regarding an interpretation language of the interpreter, in a pair with an interpreter identifier for identifying the interpreter; and a language setting unit that acquires a set of a first language identifier and a second language identifier that is paired with the interpretation language information contained in the setting result, from the storage unit, accumulates the first language identifier and the second language identifier constituting the acquired set, in association with the interpreter identifier, and accumulates the first language identifier constituting the acquired set, in association with the interpreter identifier.

With this configuration, it is possible to properly set an interpretation language of each of one or more interpreters and a language of a speaker corresponding to an interpreter.

A second aspect of the present invention is directed to the server apparatus according to the first aspect, further including a distributing unit that transmits interpreter setting screen information, which is information of a screen on which an interpreter sets one speaker out of one or more speakers and one interpretation language out of one or more interpretation languages, to an interpreter apparatus of each of one or more interpreters, wherein the receiving unit receives a setting result further containing a speaker identifier for identifying a speaker subjected to interpretation by an interpreter, in a pair with an interpreter identifier for identifying the interpreter, from an interpreter apparatus of each of one or more interpreters.

With this configuration, it is possible to easily and properly set an interpretation language of each of one or more interpreters and a language of a speaker corresponding to an interpreter.

Note that, in the second aspect of the present invention, the server apparatus may further include a screen information configuring unit that configures interpreter setting screen information, which is information of a screen on which an interpreter sets one speaker out of one or more speakers and one interpretation language out of one or more interpretation languages, wherein the distributing unit may transmit the interpreter setting screen information configured by the screen information configuring unit, to an interpreter apparatus of each of one or more interpreters.

A third aspect of the present invention is directed to the server apparatus according to the first or second aspect, wherein the language setting unit accumulates a second language identifier constituting the acquired set, in the storage unit, the distributing unit transmits user setting screen information, which is information of a screen on which a user at least sets a primary second language corresponding to one second language identifier out of one or more second language identifiers stored in the storage unit, to a terminal apparatus of each of one or more users, and the receiving unit receives a setting result at least containing a primary second language identifier for identifying a primary second language set by a user, in a pair with a user identifier for identifying the user, from a terminal apparatus of each of one or more users, and the language setting unit accumulates at least the primary second language identifier contained in the setting result, in association with the user identifier.

With this configuration, it is also possible to properly set a language of each of one or more users.

Note that, in the third of the present invention according to the first aspect, the server apparatus may further include a screen information configuring unit that configures user setting screen information, which is information of a screen on which a user at least sets a primary second language corresponding to one second language identifier out of one or more second language identifiers stored in the storage unit, wherein the distributing unit may transmit the user setting screen information configured by the screen information configuring unit, to an interpreter apparatus of each of one or more users.

Furthermore, in the third of the present invention according to the second aspect, the screen information configuring unit may further configure user setting screen information, which is information of a screen on which a user at least sets a primary second language corresponding to one second language identifier out of one or more second language identifiers stored in the storage unit, and the distributing unit may further transmit the user setting screen information configured by the screen information configuring unit, to an interpreter apparatus of each of one or more users.

### Advantageous Effects of Invention

According to the present invention, it is possible to realize a mechanism for accumulating first audio and second audio, which is audio obtained through simultaneous interpretation of the first audio, in association with each other.

### BRIEF DESCRIPTION OF DRAWINGS

FIG. 1 is a block diagram of an interpretation system according to Embodiment 1.

FIG. 2 is a flowchart illustrating an operation of a server apparatus according to the embodiment.

FIG. 3 is a flowchart illustrating an operation of a server apparatus according to the embodiment.

FIG. 4 is a flowchart illustrating an operation of a terminal apparatus according to the embodiment.

FIG. 5 is a data structure diagram of speaker information according to the embodiment.

FIG. 6 is a data structure diagram of interpreter information according to the embodiment.

FIG. 7 is a data structure diagram of user information according to the embodiment.

FIG. 8 is a block diagram of an interpreter apparatus in a modified example according to the embodiment.

FIG. 9 is a flowchart illustrating language setting processing, which is added to the flowcharts in FIGS. 2 and 3, in the modified example according to the embodiment.

FIG. 10 is a flowchart illustrating interpreter/speaker language setting processing according to the embodiment.

FIG. 11 is a flowchart illustrating user language setting processing according to the embodiment.

FIG. 12 is a diagram showing an example of an interpreter setting screen according to the embodiment.

FIG. 13 is a diagram showing an example of a user setting screen according to the embodiment.

FIG. 14 is a block diagram of an audio processing apparatus according to Embodiment 2.

FIG. 15 is a flowchart illustrating an operation of the audio processing apparatus according to the embodiment.

FIG. 16 is a flowchart illustrating sentence associating processing according to the embodiment.

FIG. 17 is a data structure diagram of a first sentence block and a second sentence block according to the embodiment.

FIG. 18 is a data structure diagram of sentence association information according to the embodiment.

FIG. 19 is an external view of a computer system according to the embodiments.

FIG. 20 is a diagram showing an example of the internal configuration of the computer system according to the embodiment.

### DESCRIPTION OF EMBODIMENTS

### Embodiment 1

Hereinafter, an embodiment of an interpretation system and the like will be described with reference to the drawings. It should be noted that constituent elements denoted by the same reference numerals in the embodiments perform similar operations, and thus a description thereof may not be repeated.

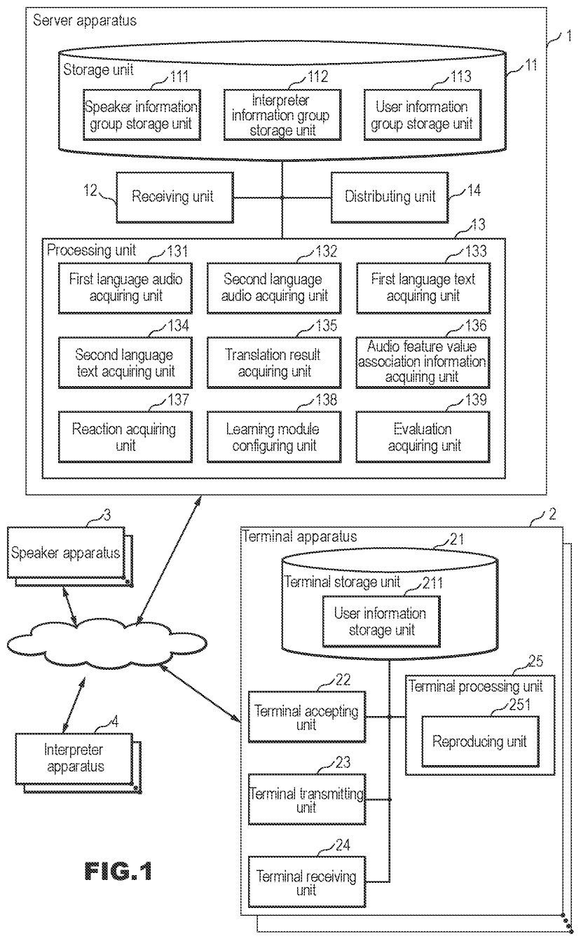

FIG. 1 is a block diagram of an interpretation system in this embodiment. The interpretation system includes a server apparatus 1 and two or more terminal apparatuses 2. For example, the server apparatus 1 is communicably connected to each of the two or more terminal apparatuses 2 via a network such as an LAN or the Internet, a wireless or wired communication line, or the like. The number of terminal apparatuses 2 constituting the interpretation system is two or more in this embodiment, but the number may be one.

For example, the server apparatus 1 is a server of an operating company that operates the interpretation system, but may also be a cloud server, an ASP server, or the like, and there is no limitation on the type or location thereof.

For example, the terminal apparatuses 2 are mobile terminals of users who use the interpretation system. The mobile terminals are portable terminals, and examples thereof include a smartphone, a tablet device, a mobile phone, and a laptop PC, but there is no limitation on the type thereof. It is also possible that the terminal apparatuses 2 are desktop terminals, but there is no limitation on the type thereof.

The interpretation system typically includes one or at least two speaker apparatuses 3 and one or at least two interpreter apparatuses 4 as well. The speaker apparatuses 3 are terminal apparatuses of speakers who speak in a seminar, a debate, or the like. For example, the speaker apparatuses 3 are desktop terminals, but they may be mobile terminals or microphones, but there is no limitation on the type thereof. The interpreter apparatuses 4 are terminal apparatuses of interpreters who interpret speech of a speaker. The interpreter apparatuses 4 are also desktop terminals, for example, but they may be mobile terminals or microphones, but there is no limitation on the type thereof. The terminals that realize the speaker apparatuses 3 and the like are communicably connected to the server apparatus 1 via a network or the like. The microphones that realize the speaker apparatuses 3 and the like are connected to the server apparatus 1 in a wired or wireless manner, for example, but they may be communicably connected to the server apparatus 1 via a network or the like.

The server apparatus 1 includes a storage unit 11, a receiving unit 12, a processing unit 13, and a distributing unit 14. The storage unit 11 includes a speaker information group storage unit 111, an interpreter information group storage unit 112, and a user information group storage unit 113. The processing unit 13 includes a first language audio acquiring unit 131, a second language audio acquiring unit 132, a first language text acquiring unit 133, a second language text acquiring unit 134, a translation result acquiring unit 135, an audio feature value association information acquiring unit 136, a reaction acquiring unit 137, a learning module configuring unit 138, and an evaluation acquiring unit 139.

The terminal apparatuses 2 each include a terminal storage unit 21, a terminal accepting unit 22, a terminal transmitting unit 23, a terminal receiving unit 24, and a terminal processing unit 25. The terminal storage unit 21 includes a user information storage unit 211. The terminal processing unit 25 includes a reproducing unit 251.

Various types of information may be stored in the storage unit 11 constituting the server apparatus 1. The various types of information are, for example, a later-described speaker information group, a later-described interpreter information group, a later-described user information group, or the like.

Furthermore, a result of processing performed by the processing unit 13 is also stored in the storage unit 11. The result of processing performed by the processing unit 13 is, for example, first language audio acquired by the first language audio acquiring unit 131, second language audio acquired by the second language audio acquiring unit 132, first language text acquired by the first language text acquiring unit 133, second language text acquired by the second language text acquiring unit 134, a translation result acquired by the translation result acquiring unit 135, audio feature value association information acquired by the audio feature value association information acquiring unit 136, reaction information acquired by the reaction acquiring unit 137, a learning module configured by the learning module configuring unit 138, an evaluation value acquired by the evaluation acquiring unit 139, or the like. These types of information will be described later.

A speaker information group is stored in the speaker information group storage unit 111. The speaker information group is a group of one or more pieces of speaker information. The speaker information is information regarding a speaker. The speaker is a person who speaks. The speaker is, for example, a lecturer who gives a lecture at a seminar, a debater who has a debate at a debate, or the like, but there is no limitation on the speaker.

The speaker information has, for example, a speaker identifier and a first language identifier. The speaker identifier is information for identifying a speaker. The speaker identifier is, for example, a name, an e-mail address, a mobile phone number, an ID, or the like, but may also be a terminal identifier (e.g., a MAC address, an IP address, etc.) for identifying a mobile terminal of a speaker, and any information is possible as long as a speaker can be identified. The speaker identifier is not absolutely necessary. For example, if the number of speakers is only one, the speaker information does not have to have a speaker identifier.

The first language identifier is information for identifying a first language. The first language is a language that is spoken by a speaker. The first language is, for example, Japanese, but there is no limitation on the language, and examples thereof include English, Chinese, and French. The first language identifier is, for example, a language name such as “Japanese” or “English”, but may also be an abbreviation such as “jpn” or “eng”, or an ID, and any information is possible as long as a first language can be identified.

One or at least two speaker information groups may be stored in the speaker information group storage unit 111, for example, in association with a place identifier. The place identifier is information for identifying a place. The place is a place at which a speaker speaks. The place is, for example, a conference hall, a class room, a hall, or the like, but there is no limitation on the type or location thereof. The place identifier is, for example, a place name, an ID, or the like, and any information is possible as long as a place can be identified.

The speaker information group is not absolutely necessary, and the server apparatus 1 does not have to include the speaker information group storage unit 111.

An interpreter information group is stored in the interpreter information group storage unit 112. The interpreter information group is a group of one or more pieces of interpreter information. The interpreter information is information regarding an interpreter. The interpreter is a person who performs interpretation. The interpretation is an act of interpreting audio in one language to another language while listening to the audio. The interpretation is, for example, simultaneous interpretation, but may also be consecutive interpretation. The simultaneous interpretation is an act of performing interpretation almost simultaneously with listening to speech of a speaker. The consecutive interpretation is an act of sequentially performing interpretation while breaking up speech of a speaker to portions with an appropriate length.

The interpreter interprets audio in a first language to a second language. The second language is a language used by the user for listening or reading. The second language may be any language as long as it is different from the first language. For example, if the first language is Japanese, the second language is English, Chinese, French, or the like.

Specifically, for example, a case is conceivable in which Japanese in which a lecturer a speaks at a place X is interpreted by an interpreter A to English, by an interpreter B to Chinese, and by an interpreter C to French, respectively. It is also possible that there are two or more interpreters who perform the same type of interpretation. For example, it is also possible that two interpreters A1 and A2 perform interpretation from Japanese to English, and the server apparatus 1 distributes speech interpreted by one of the interpreters A1 and A2 and text obtained from interpretation by the other of the interpreters A1 and A2, to the two or more terminal apparatuses 2.

Furthermore, a case is also conceivable in which Japanese in which a debater β speaks at another place Y is interpreted by interpreters E and F respectively to English and Chinese, and English in which a debater γ speaks at the same place is interpreted by interpreters E and G respectively to Japanese and Chinese. In this example, one interpreter E performs bidirectional interpretation between Japanese and English and between English and Japanese, but it is also possible that the interpreter E performs interpretation either between Japanese and English or between English and Japanese, and the other interpretation is performed by another interpreter H.

The interpreters typically perform interpretation at a place at which a speaker speaks, but they may perform interpretation at another place, but there is no limitation on the location thereof. The other place is, for example, a room of an operating company or interpreter's home, and any place is possible. If interpretation is performed at another place, audio of speech uttered by a speaker is transmitted from the speaker apparatuses 3 via a network or the like to the interpreter apparatuses 4.

The interpreter information has, for example, a first language identifier, a second language identifier, and an interpreter identifier. The second language identifier is information for identifying the above-described second language. The second language identifier is, for example, a language name, an abbreviation, an ID, or the like, and any type of identifier is possible. The interpreter identifier is information for identifying an interpreter. The interpreter identifier is, for example, a name, an e-mail address, a mobile phone number, an ID, a terminal identifier, or the like, and any type of identifier is possible.

Furthermore, it can be said that the interpreter information is constituted by interpreter language information and an interpreter identifier. The interpreter language information is information regarding a language of an interpreter, and the interpreter language information has, for example, a first language identifier, a second language identifier, and an evaluation value. The evaluation value is a value indicating an evaluation regarding the quality of interpretation performed by an interpreter. The quality is, for example, how easily the interpretation is understandable, how small the number of misinterpretations is, and the like. The evaluation value is acquired, for example, based on a reaction from a user who listened to speech interpreted by an interpreter. The evaluation value is, for example, a numerical value such as “5”, “4”, or “3”, but may also be a text character such as “A”, “B”, or “C”, but there is no limitation on the expression form thereof.

It is also possible that, for example, one or at least two interpreter information groups are stored in the interpreter information group storage unit 112 in association with a place identifier.

A user information group is stored in the user information group storage unit 113. The user information group is a group of one or at least two pieces of user information. The user information is information regarding a user. The user is a user of the interpretation system as described above. The user can listen to interpreted audio, which is audio obtained by interpreting speech of a speaker, via the terminal apparatus 2. The user can also read interpretation text, which is text obtained through speech recognition of the interpreted audio.

The user typically listens to interpreted audio at a place at which a speaker is present, but he or she may listen to the interpreted audio at another place, but there is no limitation on the location thereof. The other place is, for example, user's home or a train, and any place is possible.

The user information has a user identifier and a second language identifier. The user identifier is information for identifying a user. The user identifier is, for example, a name, an e-mail address, a mobile phone number, an ID, a terminal identifier, or the like, and any type of identifier is possible.

The second language identifier contained in the user information is information for identifying a language used by the user for listening or reading. The second language identifier contained in the user information is information based on user's choice, and is typically information that can be changed, but may also be fixed information.

Furthermore, it can be said that the user information is constituted by user language information and a user identifier. The user language information is information regarding a language of a user. The user language information has, for example, a primary second language identifier, a secondary second language identifier group, and data format information, and the like. The primary second language identifier is information for identifying a primary second language (hereinafter, referred to as a “primary second language”). The secondary second language identifier group is a group of one or at least two secondary second language identifiers. The secondary second language identifier is information for identifying a secondary second language (hereinafter, referred to as a “secondary second language”) that can be chosen in addition to the primary second language.

For example, if the primary second language is French, the secondary second language may be English or Chinese, but there is no limitation on the secondary second language as long as it is different from the primary second language.

The data format information is information regarding a data format of the second language. The data format information typically indicates a data format of the primary second language. The data format of the primary second language is audio or text, and the data format information may contain one or more data formats out of “audio” and “text”. That is to say, the primary second language may be audio, text, or both of audio and text.

In this embodiment, the data format information is, for example, information based on user's choice, and can be changed. As for the primary second language, the user may listen to audio, read text, or read text while listening to audio.

Meanwhile, in this embodiment, it is assumed that the data format of the secondary second language is text, and cannot be changed. That is to say, for example, the user can read text in the secondary second language in addition to text in the primary second language.

One or at least two pieces of user information group may be stored in the user information group storage unit 113, for example, in association with a place identifier.

The receiving unit 12 receives various types of information. The various types of information are, for example, various types of information accepted by a later-described terminal accepting unit 22 of the terminal apparatus 2, or the like.

The processing unit 13 performs various types of processing. The various types of processing are, for example, processing performed by the first language audio acquiring unit 131, the second language audio acquiring unit 132, the first language text acquiring unit 133, the second language text acquiring unit 134, the translation result acquiring unit 135, the audio feature value association information acquiring unit 136, the reaction acquiring unit 137, the learning module configuring unit 138, and the evaluation acquiring unit 139, and the like.

Furthermore, the processing unit 13 also performs various types of determination illustrated in the flowchart. Furthermore, the processing unit 13 also performs processing that accumulates information acquired by each of the first language audio acquiring unit 131, the second language audio acquiring unit 132, the first language text acquiring unit 133, the second language text acquiring unit 134, the translation result acquiring unit 135, the audio feature value association information acquiring unit 136, the reaction acquiring unit 137, and the evaluation acquiring unit 139, in the storage unit 11, in association with time information.

The time information is information indicating the time. The time information is typically information indicating the current time. It is also possible that the time information is information indicating a relative time. The relative time is a time relative to a point in time serving as a reference, such as elapsed time from the start of a seminar or the like. If information such as first language audio is acquired, the processing unit 13 acquires time information indicating the current time from a built-in clock of an MPU, an NTP server, or the like, and accumulates the information acquired by the first language audio acquiring unit 131 or the like, in the storage unit 11, in association with the time information. The information acquired by the first language audio acquiring unit 131 or the like may contain time information, and, in that case, the processing unit 13 does not have to associate the acquired information with the time information.

The first language audio acquiring unit 131 acquires first language audio. The first language audio is data of audio in the first language spoken by one speaker. The one speaker may be a single speaker (e.g., a lecturer who delivers audio in a seminar), or a currently speaking speaker among two or more speakers (e.g., two or more debaters who hold a discussion at a debate). The acquiring is typically receiving the first language audio.

That is to say, for example, the first language audio acquiring unit 131 receives one or more pieces of first language audio transmitted from one or more speaker apparatuses 3. For example, a microphone is provided at or near the mouth of a lecturer, and the first language audio acquiring unit 131 acquires first language audio via this microphone.

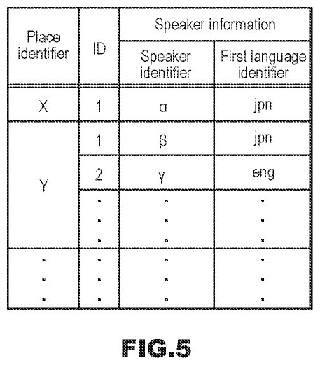

The first language audio acquiring unit 131 may acquire one or more pieces of first language audio from one or more speaker apparatuses 3, using the speaker information group. For example, if a place at which speakers speak is a studio at which there is no user, the receiving unit 12 receives speaker identifiers from the mobile terminals 2 of one or more users at home or the like. The first language audio acquiring unit 131 may transmit a request for first language audio, to the speaker apparatuses 3 of speakers identified with speaker identifiers received by the receiving unit 12, using one or more pieces of speaker information constituting a speaker information group (see FIG. 5, which will be described later), and receive first language audio transmitted from the speaker apparatuses 3 in response to the request.

The first language audio is not absolutely necessary, and the server apparatus 1 does not have to include the first language audio acquiring unit 131.

The second language audio acquiring unit 132 acquires one or more pieces of second language audio. The pieces of second language audio are data of audio obtained from audio in a first language spoken by one speaker, through interpretation performed by one or more interpreters respectively to second languages. As described above, the second languages are languages used by users for listening or reading, and may be any language as long as they are different from the first language.

It is preferable that the second languages are languages corresponding to any of the two or more language identifiers stored in the user information group storage unit 113, and are languages other than the one or more languages corresponding to the one or more second language identifiers stored in the interpreter information group storage unit 112. Alternatively, the second languages may be the same languages as any of the one or more languages corresponding to the one or more second language identifiers stored in the interpreter information group storage unit 112, as long as they are languages corresponding to any of the two or more language identifiers stored in the user information group storage unit 113.

For example, the second language audio acquiring unit 132 receives one or more pieces of second language audio transmitted from one or more interpreter apparatuses 4.

Furthermore, the second language audio acquiring unit 132 may acquire one or more pieces of second language audio from one or more interpreter apparatuses 4, using the interpreter information group. Specifically, the second language audio acquiring unit 132 acquires one or more interpreter identifiers using one or more pieces of interpreter information constituting the interpreter information group, and transmits a request for second language audio to the interpreter apparatuses 4 of the interpreters respectively identified with the acquired one or more interpreter identifiers. Then, the second language audio acquiring unit 132 receives pieces of second language audio transmitted from the interpreter apparatuses 4 in response to the request.

The first language text acquiring unit 133 acquires first language text. The first language text is data of text in a first language in which one speaker speaks. For example, the first language text acquiring unit 133 acquires first language text through speech recognition of the first language audio acquired by the first language audio acquiring unit 131. Alternatively, the first language text acquiring unit 133 may acquire first language audio through speech recognition of audio from a microphone of a speaker. Alternatively, the first language text acquiring unit 133 may acquire first language audio through speech recognition of audio from the terminal apparatuses 2 of one or more speakers, using the speaker information group.

The second language text acquiring unit 134 acquires one or more pieces of second language text. The pieces of second language text are data of text in second languages interpreted by one or more interpreters. For example, the second language text acquiring unit 134 acquires one or more pieces of second language text respectively obtained through speech recognition of the one or more pieces of second language audio acquired by the second language audio acquiring unit 132.

The translation result acquiring unit 135 acquires one or more translation results. The translation result is a result obtained through translation performed using a translation engine from the first language text. The translation performed using a translation engine is a known technique, and thus a description thereof has been omitted. The translation result contains one or more pieces of data among translated text and translation audio. The translated text is text obtained through translation from the first language text to the second language. The translation audio is audio obtained through conversion from the translated text into audio. The conversion into audio can be said to be audio synthesis.

For example, it is preferable that the translation result acquiring unit 135 acquires only one or more translation results corresponding to one or more second language identifiers that are different from the one or more second language identifiers contained in the interpreter information group, and does not acquire one or more translation results corresponding to one or more second language identifiers that are the same as any of the one or more second language identifiers contained in the interpreter information group, among the two or more second language identifiers contained in the user information group.

Specifically, for example, the translation result acquiring unit 135 determines, for each of the two or more second language identifiers contained in the user information group, whether or not the second language identifier is different from the one or more second language identifiers contained in the interpreter information group. Then, the translation result acquiring unit 135 acquires one or more second language identifiers that are different from the one or more second language identifiers contained in the interpreter information group, but does not acquire second language identifiers that are the same as any of the one or more second language identifiers contained in the interpreter information group.

The audio feature value association information acquiring unit 136 acquires audio feature value association information, using the first language audio acquired by the first language audio acquiring unit 131 and the one or more pieces of second language audio acquired by the second language audio acquiring unit 132, for each of the one or more pieces of language information. The audio feature value association information is information indicating association between feature values in a set of first language audio and second language audio.

The language information is information regarding a language. The language information is, for example, a set of a first language identifier and a second language identifier (e.g., “jpn-eng”, “jpn-chi”, “jpn-fre”, etc.), but there is no limitation on the data structure. The association between first language audio and second language audio may be, for example, association in which an element is taken as a unit. The element is an element constituting a sentence. The element constituting a sentence is, for example, a morpheme. The morpheme is one or more elements constituting a sentence in a natural language. The morpheme is, for example, a word, but may also be a phrase or the like. Alternatively, an element may be a whole sentence, and any element is possible as long as it is an element of a sentence.

The feature value can be said to be, for example, information quantitatively indicating the feature of an element. The feature value is, for example, of phonemes constituting a morpheme (hereinafter, referred to as “phonemes”). Alternatively, the feature value may be the position of an accent in phonemes or the like.

For example, it is also possible that the audio feature value association information acquiring unit 136 performs, for each of the two or more pieces of language information, morphological analysis on first language audio and second language audio, thereby specifying two morphemes that correspond to each other between the first language audio and the second language audio, and acquires feature values of the two morphemes. The morphological analysis is a known technique, and thus a description thereof has been omitted.

Furthermore, it is also possible that the audio feature value association information acquiring unit 136 detects, for each of the two or more pieces of language information, one or more silence periods in first language audio and second language audio, and performs segmentation that divides audio into two or more segments at the one or more silence periods. The silence period is a period in which the state with an audio level of not greater than a threshold is maintained for a predetermined length of time or more. It is also possible that the audio feature value association information acquiring unit 136 specifies two segments that correspond to each other between the first language audio and the second language audio, and acquires feature values of the two segments. For example, it is also possible that the numbers such as “1”, “2”, and “3” are associated with the two or more segments of the first language audio, the numbers such as “1”, “2”, and “3” are associated with the two or more segments of the second language audio as well, and each pair of two segments with which the same number is associated is considered as segments that correspond to each other.

The reaction acquiring unit 137 acquires two or more pieces of reaction information. The reaction information is information regarding a reaction from the user to interpretation performed by an interpreter. The reaction information has, for example, a user identifier and a reaction type. The reaction type is information indicating the type of reaction. The reaction type is, for example, “nod”, “tilt the neck”, “laugh”, or the like, but may also be “no reaction”, but there is no limitation on the type or expression form thereof.

The reaction information does not have to have a user identifier. That is to say each user who reacted to interpretation performed by one interpreter does not have to be specified, and, for example, it is sufficient that a primary second language of the user is specified. Accordingly, the reaction information may have, for example, a second language identifier instead of the user identifier. Furthermore, for example, if the number of interpreters is only one, it is possible that the reaction information is information merely indicating the reaction type.

If the number of interpreters is two or more, for example, the place is divided into two or more second language partitions (e.g., an English partition, a Chinese partition, etc.) corresponding to the two or more interpreters. Then, the front side of each of the two or more language partitions is provided with a camera capable of capturing an image of faces of one or more users in the partition.

The reaction acquiring unit 137 receives an image from the camera of each of the two or more language partitions, and performs face detection from the image, thereby acquiring one or more face images of users in the partition. The face detection is a known technique, and thus a description thereof has been omitted. A group of pairs of a feature value of a face image and a reaction type (e.g., “nod”, “tilt the neck”, “laugh”, etc.) is stored in the storage unit 11, and the reaction acquiring unit 137 acquires, for each of the one or more face images, a feature value from the face image, and specifies a reaction type corresponding to the feature value, thereby acquiring one or more pieces of reaction information regarding a visible reaction of each or a group of the one or more users in the partition.

Furthermore, the left and right sides in the place may be provided with a pair of microphones capable of detecting a sound (e.g., clapping sound, laughter, etc.) that is generated in each of the two or more language partitions. A group of pairs of a feature value of a sound and a reaction type (e.g., “clap”, “laugh”, etc.) is stored in the storage unit 11, and the reaction acquiring unit 137 detects generation of a sound from the left and right sound from the pair of microphones, and specifies the position of the sound source. Then, it is possible to acquire, for each of the two or more language partitions, a feature value from sound of at least one of the left and right microphones, and specify a reaction type corresponding to the feature value, thereby acquiring one or more pieces of reaction information regarding an audible reaction of a group of the one or more users in the partition.

Furthermore, it is also possible that, for example, the reaction acquiring unit 137 acquires, for each of the two or more users, reaction information to second language audio reproduced by a later-described reproducing unit 251 of the terminal apparatus 2, using the user information group.

Specifically, for example, the processing unit 13 accepts in advance, from each of the two or more users, a face image of the user via the terminal apparatus 2 of the user, and accumulates a group of pairs of a user identifier and the face image in the storage unit 11. One or at least two cameras are installed at a place, and the reaction acquiring unit 137 performs face recognition using camera images from the one or more cameras, thereby detecting face images of the two or more users. Next, the reaction acquiring unit 137 acquires, for each of the two or more user identifiers, reaction information using the two or more face images of the camera images. The processing unit 13 accumulates the reaction information acquired for each of the two or more user identifiers, in the storage unit 11, in association with time information.

Furthermore, it is also possible that the reaction acquiring unit 137 acquires, for each of the two or more users, a face image of the user via a built-in camera of the terminal apparatus 2 of the user, and acquires reaction information using the face image.

The learning module configuring unit 138 configures a learning module in which the first language audio is taken as input and the second language audio is taken as output, using two or more pieces of audio feature value association information, for each of the one or more pieces of language information. The learning module can be said to be information for outputting corresponding second language audio to input of first language audio, through machine learning of association between a feature value of the first language audio and a feature value of the second language audio, using two or more pieces of audio feature value association information as teaching data. The machine learning is, for example, deep learning, a random forest, a decision tree, or the like but there is no limitation on the type thereof. Machine learning such as deep learning is a known technique, and thus a description thereof has been omitted.

The learning module configuring unit 138 configures a learning module, using audio feature value association information acquired from two or more sets of first language audio and second language audio selected using the reaction information.

Selecting can be said to be choosing a set suitable to configure a learning module with a high level of precision, or discarding an unsuitable set. Whether or not a set is suitable is determined, for example, based on whether or not reaction information to second language audio satisfies a predetermined condition. The reaction information to second language audio is reaction information immediately after the second language audio. The predetermined condition may be, for example, “one or more of a clapping sound or a nodding motion are detected” or the like. The selecting can be realized by, for example, accumulating a suitable set or second language audio constituting the suitable set in the storage unit 11, or deleting an unsuitable set or second language audio constituting the unsuitable set from the storage unit 11. Alternatively, the selecting may be processing in which information regarding a suitable set acquired by a unit is delivered to another unit, whereas information regarding unsuitable set is discarded without being delivered.

The selecting may be performed by any unit of the server apparatus 1. For example, it is preferable that the selecting is performed by the audio feature value association information acquiring unit 136, which is on the most upstream side in the processing. That is to say for example, the audio feature value association information acquiring unit 136 determines whether or not reaction information corresponding to second language audio constituting each of two or more sets satisfies a predetermined condition, and acquires audio feature value association information from the set containing the second language audio corresponding to the reaction information determined as satisfying the condition. The second language audio corresponding to the reaction information determined as satisfying the condition is second language audio immediately before the reaction information.

It is also possible that the selecting is performed by the learning module configuring unit 138. Specifically, for example, the learning module configuring unit 138 may discard, for each of the one or more second language identifiers, audio feature value association information satisfying a predetermined condition, among the two or more pieces of audio feature value association information serving as teaching data, using the two or more pieces of reaction information acquired by the reaction acquiring unit 137.

The predetermined condition is, for example, a condition that the number or proportion of users who tilted their necks at the same time among two or more users listening to one piece of second language audio is at a threshold or more or is more than the threshold. The learning module configuring unit 138 discards, as audio feature value association information satisfying this condition, audio feature value association information corresponding to the second language audio and corresponding to the time, among the two or more pieces of audio feature value association information serving as teaching data.

The evaluation acquiring unit 139 acquires, for each of one or more interpreters, evaluation information using two or more pieces of reaction information corresponding to the interpreter. The evaluation information is information regarding an evaluation of the interpreter performed by users. The evaluation information has, for example, an interpreter identifier and an evaluation value. The evaluation value is a value indicating an evaluation. The evaluation value is, for example, a numerical value such as 5, 4, or 3, but may also be expressed as a text character such as A, B, or C.

For example, the evaluation acquiring unit 139 acquires an evaluation value, using a function in which the reaction information is taken as a parameter. Specifically, for example, the evaluation acquiring unit 139 may acquire an evaluation value using a decreasing function in which the number of times that the neck is tilted is taken as a parameter. Alternatively, the evaluation acquiring unit 139 may acquire an evaluation value using an increasing function in which one or more of the number of times that a user nods and the number of times that a user laughs is taken as a parameter.

The distributing unit 14 distributes, to each of the two or more terminal apparatuses 2, second language audio corresponding to the primary second language identifier contained in the user information corresponding to the terminal apparatus 2, out of the one or more pieces of second language audio acquired by the second language audio acquiring unit 132, using the user information group.

Furthermore, it is also possible that the distributing unit 14 distributes, to each of the two or more terminal apparatuses 2, second language text corresponding to the primary second language identifier contained in the user information corresponding to the terminal apparatus 2, out of the one or more pieces of second language text acquired by the second language text acquiring unit 134, using the user information group.

Furthermore, it is also possible that the distributing unit 14 further distributes, to each of the two or more terminal apparatuses 2, a translation result corresponding to the primary second language identifier contained in the user information corresponding to the terminal apparatus 2, out of the one or more translation results acquired by the translation result acquiring unit 135, using the user information group.

Specifically, for example, the distributing unit 14 acquires a user identifier, a primary second language identifier, and data format information using one or more pieces of user information constituting a user information group, and transmits one or more pieces of information corresponding to the acquired data format information, out of audio and text in the primary second language identified with the acquired primary second language identifier, to the terminal apparatus 2 of the user identified with the acquired user identifier.

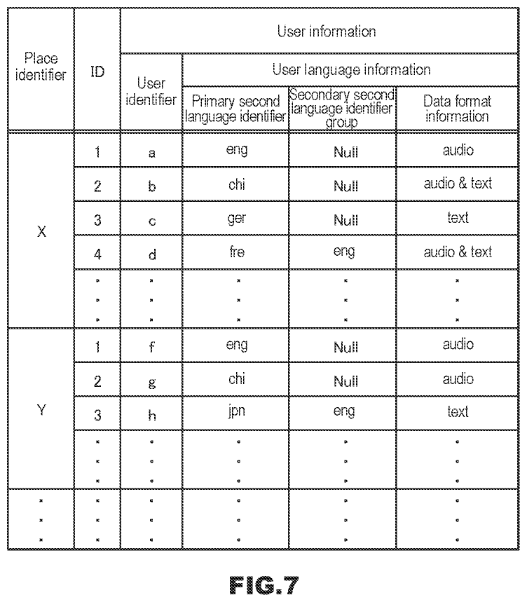

Accordingly, if a piece of user information (see a first piece of user information in FIG. 7, which will be described later, for example) has a user identifier “a”, a primary second language identifier “eng”, and data format information “audio”, audio in English identified with the primary second language identifier “eng” is distributed to the terminal apparatus 2 of the user a identified with the user identifier “a”.

Furthermore, if another piece of user information (e.g., a second piece of user information in FIG. 7) has a user identifier “b”, a primary second language identifier “chi”, and data format information “audio & text”, audio in Chinese identified with the primary second language identifier “chi” is distributed together with text in Chinese to the terminal apparatus 2 of the user b identified with the user identifier “b”.

Furthermore, if another piece of user information (e.g., a third piece of user information in FIG. 7) has a user identifier “c”, a primary second language identifier “ger”, and data format information “text”, translated text in German identified with the primary second language identifier “ger” is distributed to the terminal apparatus 2 of the user c identified with the user identifier “c”.

Moreover, it is also possible that the distributing unit 14 further distributes, to each of the two or more terminal apparatuses 2, one or more pieces of second language text corresponding to the secondary second language identifier group contained in the user information corresponding to the terminal apparatus 2, out of the one or more pieces of second language text acquired by the second language text acquiring unit 134, using the user information group.

Specifically, if another piece of user information (e.g., a fourth piece of user information in FIG. 7) has a user identifier “d”, a primary second language identifier “fre”, a secondary language identifier group “eng”, and data format information “audio & text”, audio in French identified with the primary second language identifier “fre” is distributed together with two types of text in French and English to the terminal apparatus 2 of the user d identified with the user identifier “d”.

It is also possible that the distributing unit 14 distributes one or more of second language audio and second language text, for example, in a pair with the second language identifier. Alternatively, it is also possible that the distributing unit 14 distributes one or more of second language audio and second language text in a pair with the interpreter identifier and the second language identifier.

Furthermore, it is also possible that the distributing unit 14 distributes one or more of first language audio and first language text, for example, in a pair with the first language identifier. Alternatively, it is also possible that the distributing unit 14 distributes one or more of first language audio and first language text in a pair with the speaker identifier and the first language identifier.

Furthermore, it is also possible that the distributing unit 14 distributes one or more translation results, for example, in a pair with the second language identifier. Alternatively, it is also possible that the distributing unit 14 distributes one or more translation results in a pair with the second language identifier and information indicating that the results were obtained by a translation engine.

It is not absolutely necessary to distribute a language identifier such as a second language identifier, and it is sufficient that the distributing unit 14 distributes only one or more types of information of audio such as second language audio and text such as second language text.

Various types of information may be stored in the terminal storage unit 21 constituting each of the terminal apparatuses 2. The various types of information are, for example, user information. Various types of information received by a later-described terminal receiving unit 24 are also stored in the terminal storage unit 21.

User information regarding a user of the terminal apparatus 2 is stored in the user information storage unit 211. As described above, the user information has, for example, a user identifier and language information. The language information has a primary second language identifier, a secondary second language identifier group, and data format information.

It is not absolutely necessary that user information is stored in the terminal apparatus 2, and the terminal storage unit 21 does not have to include the user information storage unit 211.

For example, the terminal accepting unit 22 can accept various operations via an input device such as a touch panel or a keyboard. The various operations are, for example, an operation that chooses a primary second language. The terminal accepting unit 22 accepts such an operation, and acquires a primary second language identifier.

Furthermore, the terminal accepting unit 22 can further accept an operation that chooses one or more data formats out of audio and text for the primary second language. The terminal accepting unit 22 accepts this operation, and acquires data format information.

Furthermore, in the case in which at least text is chosen as the data format, the terminal accepting unit 22 can also accept an operation that further chooses one or more second language identifiers that are different from the second language identifier contained in the user information regarding the user of the terminal apparatus 2, out of the two or more second language identifiers contained in the translator information group. The terminal accepting unit 22 accepts this operation, and acquires a secondary second language identifier group.

The terminal transmitting unit 23 transmits the various types of information (e.g., the primary second language identifier, the secondary second language identifier group, the data format information, etc.) accepted by the terminal accepting unit 22, to the server apparatus 1.

The terminal receiving unit 24 receives the various types of information (e.g., the second language audio, the one or more pieces of second language text, the translation result, etc.) distributed from the server apparatus 1.

The terminal receiving unit 24 receives second language audio distributed from the server apparatus 1. The second language audio distributed from the server apparatus 1 to the terminal apparatus 2 is second language audio corresponding to the primary second language identifier contained in the user information corresponding to the terminal apparatus 2.

Furthermore, the terminal receiving unit 24 also receives one or more pieces of second language text distributed from the server apparatus 1. The one or more pieces of second language text distributed from the server apparatus 1 to the terminal apparatus 2 is, for example, second language text corresponding to the primary second language identifier contained in the user information corresponding to the terminal apparatus 2. Alternatively, the one or more pieces of second language text distributed from the server apparatus 1 to the terminal apparatus 2 may be second language text corresponding to the primary second language identifier contained in the user information corresponding to the terminal apparatus 2, and one or more pieces of second language text corresponding to the secondary second language identifier group contained in the user information.

That is to say, for example, the terminal receiving unit 24 also receives second language text in a secondary second language, which is another language, in addition to the second language text obtained through speech recognition of the second language audio.

The terminal processing unit 25 performs various types of processing. The various types of processing are, for example, processing performed by the reproducing unit 251. For example, the terminal processing unit 25 also performs various types of determination and accumulation illustrated in the flowchart. The accumulation is processing that accumulates the information received by the terminal receiving unit 24 in the terminal storage unit 21 in association with time information.

The reproducing unit 251 reproduces the second language audio received by the terminal receiving unit 24. The reproducing the second language audio typically includes output of audio via a speaker device, but may also be considered not to include it.

The reproducing unit 251 also outputs the one or more pieces of second language text. The outputting the second language text is typically display on a display screen, but may also be considered to include, for example, accumulation in a storage medium, printing by a printer, transmission to an external apparatus, delivery to another program, and the like.

The reproducing unit 251 outputs the second language text and the second language text in the secondary second language received by the terminal receiving unit 24.

When resuming reproduction of second language audio after an interruption, the reproducing unit 251 performs chasing-reproduction of an un-reproduced portion in the second language audio, in fast-forward. The chasing-reproduction is processing that, after interrupting reproduction, reproduces the un-reproduced portion stored in the storage unit 11 from its beginning, while performing accumulation (which may be referred to as buffering or queueing, for example) of the second language audio received from the server apparatus 1 in the storage unit 11. If the reproducing speed of the chasing-reproduction is the same as the ordinary reproducing speed, a state in which the reproduction of the second language audio after the resuming is delayed from the real-time reproduction of the second language audio by a fixed period of time continues. The fixed period of time is a delay time when the reproduction was resumed. The delay time can be said to be, for example, a time by which the reproduction is behind the time at which the un-reproduced portion was to be reproduced.

On the other hand, if the reproducing speed of the chasing-reproduction is higher than the ordinary reproducing speed, the reproduction of the second language audio after the resuming gradually catches up with the real-time reproduction of the second language audio. The time taken until the reproduction catches up with the real-time reproduction depends on the delay time when the reproduction was resumed and the reproducing speed of the chasing-reproduction.

Specifically, for example, in the case in which, when the terminal apparatus 2 is reproducing second language audio, an un-reproduced portion in the second language audio stored in the terminal storage unit 21 has a missing part (e.g., a lost packet), the terminal transmitting unit 23 transmits a resend request (e.g., having the second language identifier, the time information, etc.) for the missing part, to the server apparatus 1 that is paired with the terminal identifier (which may also function as the user identifier).

The distributing unit 14 of the server apparatus 1 resends the missing part to the terminal apparatus 2. The terminal receiving unit 24 of the terminal apparatus 2 receives the missing part, the terminal processing unit 25 accumulates the missing part in the terminal storage unit 21, and thus the un-reproduced portion stored in the terminal storage unit 21 can be reproduced. However, the reproduction of the second language audio after the resuming is delayed from speech of a speaker or speech interpreted by an interpreter, and thus the reproducing unit 251 performs the chasing-reproduction of the second language audio stored in the terminal storage unit 21, in fast-forward.

The reproducing unit 251 performs chasing-reproduction of an un-reproduced portion in fast-forward at a speed corresponding to one or more of a delay time of the un-reproduced portion and a data size of the un-reproduced portion.

If the second language audio is a stream, for example, a delay time of the un-reproduced portion can be acquired using a difference between a timestamp of a packet at the beginning of the un-reproduced portion (the oldest packet) and a current time indicated by a built-in clock or the like. That is to say, for example, when the reproduction is resumed, the reproducing unit 251 acquires a timestamp from a packet at the beginning of the un-reproduced portion and a current time from a built-in clock or the like, and calculates a difference between the timestamp time and the current time, thereby acquiring a delay time. For example, it is also possible that a group of pairs of a difference and a delay time is stored in the terminal storage unit 21, and the reproducing unit 251 acquires a delay time that is paired with the calculated difference.

Furthermore, a data size of the un-reproduced portion can be acquired, for example, using the remaining amount in the audio buffer of the terminal storage unit 21. That is to say, for example, the reproducing unit 251 can acquire the remaining amount in the audio buffer when the reproduction is resumed, and subtracts the remaining amount from the buffer capacity, thereby acquiring a data size of the un-reproduced portion. Alternatively, a data size of the un-reproduced portion may be the number of packets queued. That is to say the reproducing unit 251 may count the number of packets queued in an audio queue in the terminal storage unit 21 when the reproduction is resumed, and acquire the number of packets or the data size according to the number of packets.

Furthermore, if the second language audio is a stream, for example, fast-forward reproduction is realized by decimating some of the successively arranged packets constituting the stream at a constant ratio. For example, 2 speed is realized by decimating packets at a ratio of one out of every two packets, and 1.5 speed is realized by decimating packets at a ratio of one out of every three packets.

For example, it is also possible that a group of pairs of one or more types of information of a delay time and a data size and a reproducing speed is stored in the terminal storage unit 21, and the reproducing unit 251 acquires a reproducing speed that is paired with one or more types of information of a delay time and a data size acquired as described above when the reproduction is resumed, and performs decimation at a ratio according to the acquired reproducing speed, thereby performing chasing-reproduction of the un-reproduced portion in fast-forward at the reproducing speed.

For example, association information regarding association between one or more of a delay time and a data size, and a speed is stored in the storage unit 11, and the reproducing unit 251 acquires a speed corresponding to the one or more of a delay time of the un-reproduced portion and a data size of the un-reproduced portion using the association information, and performs reproduction in fast-forward at the acquired speed.

Furthermore, it is also possible that a function corresponding to the association information is stored in the storage unit 11, and the reproducing unit 251 calculates a speed by substituting one or more of a delay time of the un-reproduced portion and a data size of the un-reproduced portion for the function, and performs reproduction in fast-forward at the calculated speed.

For example, the reproducing unit 251 starts chasing-reproduction of an un-reproduced portion in response to a data size of the un-reproduced portion exceeding a predetermined threshold or reaching the threshold.

The reproducing unit 251 also outputs the translation result. The outputting a translation result may be considered to include or to not include output of translation audio via a speaker device, and may be considered to include or to not include display of translated text on a display screen.

The storage unit 11, the speaker information group storage unit 111, the interpreter information group storage unit 112, the user information group storage unit 113, the terminal storage unit 21, and the user information storage unit 211 are, for example, preferably non-volatile storage media such as hard disks or flash memories, but can also be realized by volatile storage media such as RAMs.

There is no limitation on the procedure in which information is stored in the storage unit 11 and the like. For example, information may be stored in the storage unit 11 and the like via a storage medium, information transmitted via a network, a communication line, or the like may be stored in the storage unit 11 and the like, or information input via an input device may be stored in the storage unit 11 and the like. There is no limitation on the input device, and examples thereof include a keyboard, a mouse, and a touch panel.

The receiving unit 12 and the terminal receiving unit 24 are typically realized by wired or wireless communication parts (e.g., a communication module such as a NIC (network interface controller) or a modem), but may also be realized by broadcast receiving parts (e.g., broadcast receiving modules).

The processing unit 13, the first language audio acquiring unit 131, the second language audio acquiring unit 132, the first language text acquiring unit 133, the second language text acquiring unit 134, the translation result acquiring unit 135, the audio feature value association information acquiring unit 136, the reaction acquiring unit 137, the learning module configuring unit 138, the evaluation acquiring unit 139, the terminal processing unit 25, and the reproducing unit 251 may be realized typically by MPUs, memories, or the like. Typically, the processing procedure of the processing unit 13 and the like is realized by software, and the software is stored in a storage medium such as a ROM. Note that they may be realized also by hardware (dedicated circuits).

The distributing unit 14 and the terminal transmitting unit 23 are typically realized by wired or wireless communication parts, but may also be realized by broadcasting parts (e.g., broadcasting modules).

The terminal accepting unit 22 may be considered to include or to not include an input device. The terminal accepting unit 22 may be realized by driver software for an input device, a combination of an input device and driver software therefor, or the like.

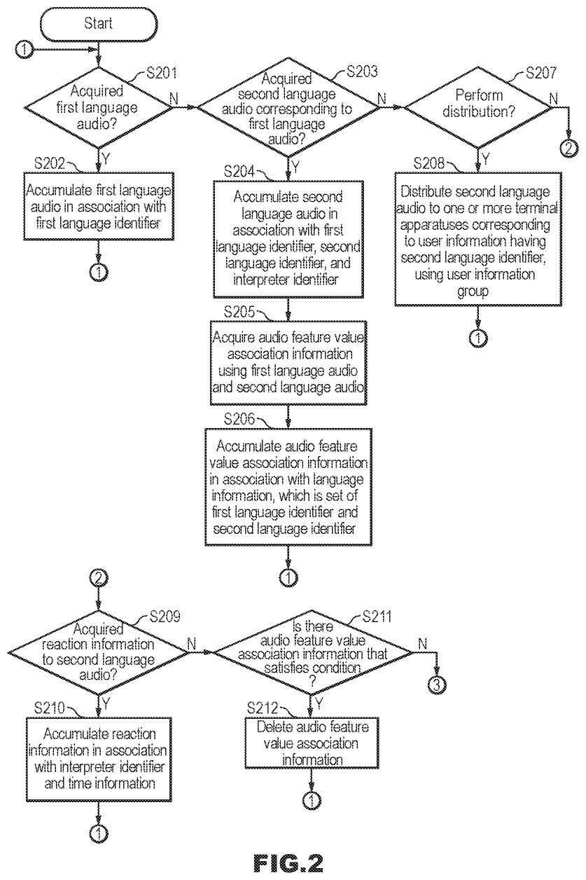

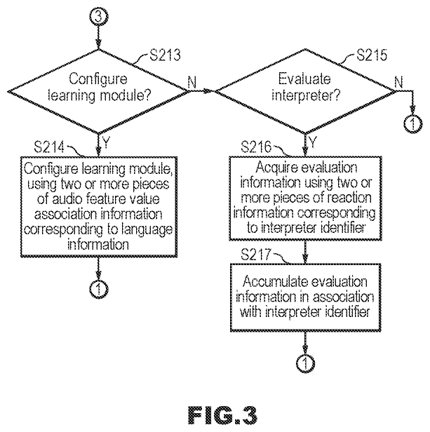

Next, an operation of the interpretation system will be described with reference to the flowcharts in FIGS. 2 to 4. FIGS. 2 and 3 are flowcharts illustrating an operation example of the server apparatus 1.

(Step S201) The processing unit 13 determines whether or not the first language audio acquiring unit 131 has acquired first language audio. If the first language audio acquiring unit 131 has acquired first language audio, the procedure advances to step S202, or otherwise the procedure advances to step S203.

(Step S202) The processing unit 13 accumulates the first language audio acquired in step S201, in the storage unit 11, in association with the first language identifier. Then, the procedure returns to step S201.

(Step S203) The processing unit 13 determines whether or not the second language audio acquiring unit 132 has acquired second language audio corresponding to the first language audio acquired in step S201. If the second language audio acquiring unit 132 has acquired corresponding second language audio, the procedure advances to step S, or otherwise the procedure advances to step S207.

(Step S204) The processing unit 13 accumulates the second language audio acquired in step S203, in the storage unit 11, in association with the first language identifier, the second language identifier, and the interpreter identifier.

(Step S205) The audio feature value association information acquiring unit 136 acquires audio feature value association information using the first language audio acquired in step S201 and the second language audio acquired in step S203.

(Step S206) The processing unit 13 accumulates the audio feature value association information acquired in step S205, in the storage unit 11, in association with language information, which is a set of the first language identifier and the second language identifier. Then, the procedure returns to step S201.

(Step S207) The distributing unit 14 determines whether or not to perform distribution. For example, if second language audio is acquired in step S203, the distributing unit 14 determines to perform distribution.

Alternatively, it is also possible that, if the data size of the second language audio stored in the storage unit 11 is at a threshold or more or is more than the threshold, the distributing unit 14 determines to perform distribution. Alternatively, it is also possible that distribution time information indicating the time at which to perform distribution is stored in the storage unit 11, and, if the current time acquired from a built-in clock or the like matches the time indicated by the distribution time information and the data size of the stored second language audio is at a threshold or more or is more than the threshold, the distributing unit 14 determines to perform distribution. If distribution is to be performed, the procedure advances to step S208, or otherwise the procedure advances to step S209.

(Step S208) The distributing unit 14 distributes the second language audio acquired in step S203 or the second language audio stored in the storage unit 11, to one or more terminal apparatuses 2 corresponding to user information having the second language identifier, using the user information group. Then, the procedure returns to step S201.

(Step S209) The processing unit 13 determines whether or not the reaction acquiring unit 137 has acquired reaction information to the second language audio distributed in step S208. If the reaction acquiring unit 137 has acquired reaction information to the distributed second language audio, the procedure advances to step S210, or otherwise the procedure advances to step S211.

(Step S210) The processing unit 13 accumulates the reaction information acquired in step S209, in the storage unit 11, in association with the interpreter identifier and time information. Then, the procedure returns to step S201.

(Step S211) The processing unit 13 determines whether or not there is audio feature value association information that satisfies a condition, among the two or more pieces of audio feature value association information stored in the storage unit 11. If there is audio feature value association information that satisfies a condition, the procedure advances to step S212, or otherwise the procedure advances to step S213.

(Step S212) The processing unit 13 deletes the audio feature value association information that satisfies the condition, from the storage unit 11. Then, the procedure returns to step S201.

(Step S213) The learning module configuring unit 138 determines whether or not to configure a learning module. For example, configuring time information indicating the time at which to configure a learning module is stored in the storage unit 11, and, if the current time matches the time indicated by the configuring time information and the number of pieces of audio feature value association information corresponding to the language information in the storage unit 11 is at a threshold or more or more than the threshold, the learning module configuring unit 138 determines to configure a learning module. If a learning module is to be configured, the procedure advances to step S214, or otherwise the procedure returns to step S201.

(Step S214) The learning module configuring unit 138 configures a learning module, using the two or more pieces of audio feature value association information corresponding to the language information. Then, the procedure returns to step S201.

(Step S215) The evaluation acquiring unit 139 determines whether or not to evaluate an interpreter. For example, evaluation time information indicating the time at which to evaluate an interpreter is stored in the storage unit 11, and, if the current time matches the time indicated by the evaluation time information, the evaluation acquiring unit 139 determines to evaluate an interpreter. If an interpreter is to be evaluated, the procedure advances to step S216, or otherwise the procedure returns to step S201.

(Step S216) The evaluation acquiring unit 139 acquires, for each of the one or more interpreter identifiers, evaluation information using the two or more pieces of reaction information corresponding to the interpreter identifier.

(Step S217) The processing unit 13 accumulates the evaluation information acquired in step S216, in the interpreter information group storage unit 112, in association with the interpreter identifier. Then, the procedure returns to step S201.

Although not shown in the flowchart in FIGS. 2 and 3, for example, the processing unit 13 also performs processing such as receiving of a missing part resend request from the terminal apparatus 2 and resend control in response to the resend request.

Furthermore, in the flowchart in FIGS. 2 and 3, the processing is started when the server apparatus 1 is turned on or a program is started, and the processing is ended when the apparatus is turned off or at an interruption of termination processing. There is no limitation on a trigger to start or end the processing.

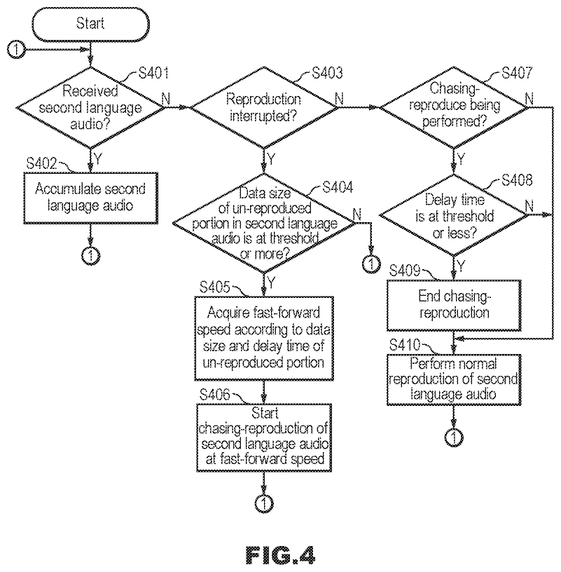

FIG. 4 is a flowchart illustrating an operation example of the terminal apparatus 2.

(Step S401) The terminal processing unit 25 determines whether or not the terminal receiving unit 24 has received second language audio. If the terminal receiving unit 24 has received second language audio, the procedure advances to step S402, or otherwise the procedure advances to step S403.

(Step S402) The terminal processing unit 25 accumulates the second language audio in the terminal storage unit 21. Then, the procedure returns to step S401.

(Step S403) The terminal processing unit 25 determines whether or not the reproduction of the second language audio has been interrupted. If the reproduction of the second language audio has been interrupted, the procedure advances to step S404, or otherwise the procedure advances to step S407.

(Step S404) The terminal processing unit 25 determines whether or not the data size of an un-reproduced portion in the second language audio stored in the terminal storage unit 21 is at a threshold or more. If the data size of an un-reproduced portion in the stored second language audio is at a threshold or more, the procedure advances to step S405, or otherwise the procedure returns to step S401.

(Step S405) The terminal processing unit 25 acquires a fast-forward speed according to the data size and the delay time of the un-reproduced portion.

(Step S406) The reproducing unit 251 starts processing that performs chasing-reproduction of the second language audio at the fast-forward speed acquired in step S405. Then, the procedure returns to step S401.

(Step S407) The terminal processing unit 25 determines whether or not chasing-reproduce is being performed. If chasing-reproduce is being performed, the procedure advances to step S408, or otherwise the procedure advances to step S410.

(Step S408) The terminal processing unit 25 determines whether or not the delay time is at a threshold or less. If the delay time is at a threshold or less, the procedure advances to step S409, or otherwise the procedure returns to step S401.

(Step S409) The reproducing unit 251 ends the chasing-reproduction of the second language audio.

(Step S410) The reproducing unit 251 performs normal reproduction of the second language audio. The normal reproduction is reproduction that is performed in real-time at a normal speed. Then, the procedure returns to step S401.

Although not shown in the flowchart in FIG. 4, for example, the terminal processing unit 25 also performs processing such as transmission of a missing part resend request to the server apparatus 1 and receiving of a missing part.

Furthermore, in the flowchart in FIG. 4, the processing started when the terminal apparatus 2 is turned on or a program is started, and the processing is ended when the apparatus is turned off or at an interruption of termination processing. There is no limitation on a trigger to start or end the processing.

Hereinafter, a specific operation example of the interpretation system in this embodiment will be described. The interpretation system originally includes a server apparatus 1, two or more terminal apparatuses 2, and two or more speaker apparatuses 3. The server apparatus 1 is communicably connected to each of the two or more terminal apparatuses 2 and the two or more speaker apparatuses 3 via a network or a communication line. The server apparatus 1 is a server of an operating company, and the terminal apparatuses 2 are mobile terminals of users. The speaker apparatuses 3 and the interpreter apparatuses 4 are terminals installed at a place.

It is assumed that a lecturer a who is a single speaker speaks in Japanese today at a place X. There are three interpreters A to C at the place X, and Japanese in which the lecturer a speaks is interpreted by the interpreter A to English, by the interpreter B to Chinese, and by the interpreter C to French, respectively.

Furthermore, a debate between two speakers is performed at another place Y. A debater β, who is one of the speakers, speaks in Japanese, and a debater γ, who is the other speaker, speaks in English. There are three interpreters E to G at the place Y, and Japanese in which the debater β speaks is interpreted by the interpreters E and F to English and Chinese respectively, and English in which the debater γ speaks is interpreted by the interpreters E and G to Japanese and Chinese respectively.

There are two or more users a to d and the like at the place X, and there are two or more users f to h and the like at the place Y. The users can listen to interpreted audio or read interpretation text on their terminal apparatuses 2.

For example, two or more speaker information groups as shown in FIG. 5 may be stored in association with a place identifier in the speaker information group storage unit 111 of the server apparatus 1. FIG. 5 is a data structure diagram of speaker information. The speaker information has a speaker identifier and a first language identifier.

The first speaker information group associated with the place identifier “X” is constituted by only one piece of speaker information, and the second speaker information group associated with the place identifier “Y” is constituted by two pieces of speaker information.

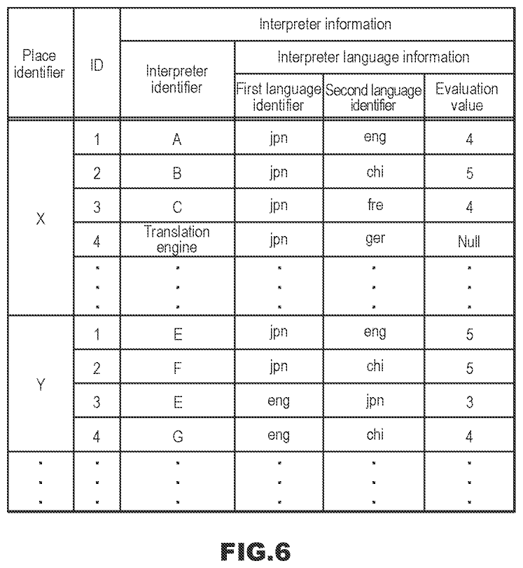

An ID (e.g., “1”, “2”, etc.) is associated with each of one or more pieces of speaker information constituting one speaker information group. For example, the ID “1” is associated with the only one piece of speaker information constituting the first speaker information group. The ID “1” is associated with the first piece of speaker information out of the two pieces of speaker information constituting the second speaker information group, and the ID “2” is associated with the second speaker information. Hereinafter, speaker information with which an ID “k” is associated is referred to as “speaker information k”. The same applies to the interpreter information shown in FIG. 6 and the user information shown in FIG. 7.

Speaker information 1 associated with a place identifier X has a speaker identifier “a” and a first language identifier “jpn”. In a similar manner, speaker information 1 associated with a place identifier Y has a speaker identifier “6” and a first language identifier “jpn”. Speaker information 2 associated with the place identifier Y has a speaker identifier “γ” and a first language identifier “eng”.

Furthermore, for example, two or more interpreter information groups as shown in FIG. 6 may be stored in the interpreter information group storage unit 112 in association with a place identifier. FIG. 6 is a data structure diagram of interpreter information. The interpreter information has an interpreter identifier and interpreter language information. The interpreter language information has a first language identifier, a second language identifier, and an evaluation value.

Interpreter information 1 associated with the place identifier X has an interpreter identifier “A”, and interpreter language information “jpn, eng, 4”. In a similar manner, interpreter information 2 associated with the place identifier X has an interpreter identifier “B” and interpreter language information “jpn, chi. 5”. Interpreter information 3 associated with the place identifier X has an interpreter identifier “C” and interpreter language information “jpn, fre, 4”. Furthermore, interpreter information 4 associated with the place identifier X has an interpreter identifier “translation engine” and interpreter language information “jpn, ger, Null”.

Interpreter information 1 associated with the place identifier Y has an interpreter identifier “E” and interpreter language information “jpn, eng, 5”. In a similar manner, interpreter information 2 associated with the place identifier Y has an interpreter identifier “F” and interpreter language information “jpn, chi, 5”. Interpreter information 3 associated with the place identifier Y has an interpreter identifier “E” and interpreter language information “eng, jpn, 3”. Furthermore, interpreter information 4 associated with the place identifier Y has an interpreter identifier “G” and interpreter language information “eng, chi, 4”.

Furthermore, for example, two or more user information groups as shown in FIG. 7 may be stored in the user information group storage unit 113 in association with a place identifier. FIG. 7 is a data structure diagram of user information. The user information has a user identifier and user language information. The user language information has a primary second language identifier, a secondary second language identifier group, and data format information.

User information 1 associated with the place identifier X has a user identifier “a” and user language information “eng, Null, audio”. In a similar manner, user information 2 associated with the place identifier X has a user identifier “b” and user language information “chi, Null, audio & text”. User information 3 associated with the place identifier X has a user identifier “c” and user language information “ger, Null, text”. Furthermore, user information 4 associated with the place identifier X has a user identifier “d” and user language information “fre, eng, audio & text”.

User information 1 associated with the place identifier Y has a user identifier “f” and user language information “eng, Null, audio”. In a similar manner, user information 2 associated with the place identifier Y has a user identifier “g” and user language information “chi, Null, audio”. User information 3 associated with the place identifier Y has a user identifier “h” and user language information “jpn, eng, text”.

Before the seminar at the place X and the debate at the place Y are started, an operator of an information system A inputs, for each place, a speaker information group and an interpreter information group via an input device such as a keyboard. The processing unit 13 of the server apparatus 1 accumulates the input speaker information group in the speaker information group storage unit 111 in association with the place identifier, and accumulates the input interpreter information group in the interpreter information group storage unit 112 in association with the place identifier. As a result, two or more pieces of speaker information as shown in FIG. 5 are stored in the speaker information group storage unit 111, and two or more pieces of interpreter information as shown in FIG. 6 are stored in the interpreter information group storage unit 112. At this point in time, all pieces of interpreter information has an evaluation value of “Null”.

The two or more users input information such as a place identifier and user information via input devices of the terminal apparatuses 2. The input information is accepted by the terminal accepting units 22 of the terminal apparatuses 2, accumulated in the user information storage units 211, and transmitted by the terminal transmitting units 23 to the server apparatus 1.

The receiving unit 12 of the server apparatus 1 receives the information from the two or more terminal apparatuses 2 and accumulates it in the user information group storage unit 113. As a result, two or more pieces of user information as shown in FIG. 7 are stored in the user information group storage unit 113.

Speaker identifiers also functioning as identifiers for identifying the speaker apparatuses 3 are respectively stored in the two or more speaker apparatuses 3. Interpreter identifiers also functioning as identifiers for identifying the interpreter apparatuses 4 are respectively stored in the two or more interpreter apparatuses 4.

During the period in which the seminar is held at the place X, the information system A performs the following processing.

When a speaker a speaks, first language audio is transmitted in a pair with the speaker identifier “a” from the speaker apparatus 3 corresponding to the speaker a to the server apparatus 1.

In the server apparatus 1, the first language audio acquiring unit 131 receives the first language audio in a pair with the speaker identifier “a”, and the processing unit 13 acquires a first language identifier “jpn” corresponding to the speaker identifier “a” from the speaker information group storage unit 111. Then, the processing unit 13 accumulates the received first language audio in the storage unit 11 in association with the first language identifier “jpn”.

Furthermore, the first language text acquiring unit 133 acquires first language text through speech recognition of the first language audio. The processing unit 13 accumulates the acquired first language text in the storage unit 11 in association with the first language audio.

Furthermore, the translation result acquiring unit 135 acquires a translation result containing translated text and translation audio through translation performed using a translation engine from the first language text to German. The processing unit 13 accumulates the acquired translation result in the storage unit 11 in association with the first language audio.

When the interpreter A interprets the speech of the speaker a to English, second language audio is transmitted in a pair with the interpreter identifier “A” from the interpreter apparatus 4 corresponding to the interpreter A.

In the server apparatus 1, the second language audio acquiring unit 132 receives the second language audio in a pair with the interpreter identifier “A”, and the processing unit 13 acquires two first and second language identifiers “jpn” and “eng” corresponding to the interpreter identifier “A” from the interpreter information group storage unit 112. Then, the processing unit 13 accumulates the received second language audio in the storage unit 11 in association with the first language identifier “jpn”, the second language identifier “eng”, and the interpreter identifier “A”. Meanwhile, the audio feature value association information acquiring unit 136 acquires audio feature value association information using the first language audio and the second language audio, and the processing unit 13 accumulates the acquired audio feature value association information in the storage unit 11 in association with language information “jpn-eng”, which is a set of the first language identifier “jpn” and the second language identifier “eng”.

When the interpreter B interprets the speech of the speaker a to Chinese, second language audio is transmitted in a pair with the interpreter identifier “B” from the interpreter apparatus 4 corresponding to the interpreter B.

In the server apparatus 1, the second language audio acquiring unit 132 receives the second language audio in a pair with the interpreter identifier “B”, and the processing unit 13 acquires two first and second language identifiers “jpn” and “chi” corresponding to the interpreter identifier “B” from the interpreter information group storage unit 112. Then, the processing unit 13 accumulates the received second language audio in the storage unit 11 in association with the first language identifier “jpn”, the second language identifier “chi”, and the interpreter identifier “B”. Meanwhile, the audio feature value association information acquiring unit 136 acquires audio feature value association information using the first language audio and the second language audio, and the processing unit 13 accumulates the acquired audio feature value association information in the storage unit 11 in association with the language information “jpn-chi”.

When the interpreter C interprets the speech of the speaker a to French, second language audio is transmitted in a pair with the interpreter identifier “C” from the interpreter apparatus 4 corresponding to the interpreter C.

In the server apparatus 1, the second language audio acquiring unit 132 receives the second language audio in a pair with the interpreter identifier “C”, and the processing unit 13 acquires two first and second language identifiers “jpn” and “fre” corresponding to the interpreter identifier “C” from the interpreter information group storage unit 112. Then, the processing unit 13 accumulates the received second language audio in the storage unit 11 in association with the first language identifier “jpn”, the second language identifier “fre”, and the interpreter identifier “C”. Meanwhile, the audio feature value association information acquiring unit 136 acquires audio feature value association information using the first language audio and the second language audio, and the processing unit 13 accumulates the acquired audio feature value association information in the storage unit 11 in association with the language information “jpn-fre”.

If the current time is the time indicated by the distribution time information, the distributing unit 14 distributes the second language audio, the second language text, and the translation result using the user information group corresponding to the place identifier X.

Specifically, the distributing unit 14 transmits the second language audio corresponding to the primary second language identifier “eng”, to the terminal apparatus 2 of the user a, using the user information 1 corresponding to the place identifier X. The distributing unit 14 transmits the second language audio corresponding to the primary second language identifier “chi” and the second language text corresponding to the primary second language identifier “chi”, to the terminal apparatus 2 of the user b, using the user information 2 corresponding to the place identifier X. The distributing unit 14 transmits the translated text corresponding to the primary second language identifier “ger”, to the terminal apparatus 2 of the user c, using the user information 3 corresponding to the place identifier X. Furthermore, the distributing unit 14 transmits the second language audio corresponding to the primary second language identifier “fre”, the second language text corresponding to the primary second language identifier “fre”, and the second language text corresponding to the secondary second language identifier group “eng”, to the terminal apparatus 2 of the user d, using the user information 4 corresponding to the place identifier X.

In each of the terminal apparatuses 2 to which the second language audio was transmitted, the terminal receiving unit 24 receives the second language audio, and the terminal processing unit 25 accumulates the received second language audio in the terminal storage unit 21. The reproducing unit 251 reproduces the second language audio stored in the terminal storage unit 21.

If the reproduction of the second language audio has been interrupted, the terminal processing unit 25 determines whether or not the data size of an un-reproduced portion in the second language audio stored in the terminal storage unit 21 is at a threshold or more. Then, if the data size of the un-reproduced portion is at a threshold or more, the terminal processing unit 25 acquires a fast-forward speed according to the data size of the un-reproduced portion and the delay time of the un-reproduced portion.

For example, assuming that the normal reproduction speed is 10 packets/sec, if the data size of the un-reproduced portion is 50 packets and the delay time of the un-reproduced portion is 5 seconds, the terminal processing unit 25 may calculate the fast-forward speed V as “10+(50/5)=20 packets/sec”. The reproducing unit 251 performs chasing-reproduction of the un-reproduced portion at the thus acquired fast-forward speed.

In each of the terminal apparatuses 2 to which one or more of the second language text and the translated text were transmitted, the terminal receiving unit 24 receives the one or more pieces of text, and the reproducing unit 251 outputs the received one or more pieces of text.

In the server apparatus 1, the reaction acquiring unit 137 acquires reaction information to the thus distributed second language audio, using one or more types of information out of an image captured by a camera installed at the place X, and voice of the two or more users a to d at the place X captured by built-in microphones of the terminal apparatuses 2 held by the users. The processing unit 13 accumulates the acquired reaction information in the storage unit 11 in association with the interpreter identifier and time information. The two or more pieces of reaction information stored in the storage unit 11 are used, for example, by the evaluation acquiring unit 139 to evaluate one or more interpreters.

Furthermore, the stored two or more pieces of reaction information are also used by the processing unit 13 to delete audio feature value association information that satisfies a predetermined condition, among the two or more pieces of audio feature value association information stored in the storage unit 11. The predetermined condition is as described above, and thus a description thereof will not be repeated. Accordingly, the level of precision of the learning module constituted by the learning module configuring unit 138 can be increased.

The configuring time information is stored in the storage unit 11, and the learning module configuring unit 138 determines whether or not the current time acquired from a built-in clock or the like is the time indicated by the configuring time information. If the current time is the time indicated by the configuring time information, the learning module configuring unit 138 configures, for each of the two or more pieces of language information, a learning module using the two or more pieces of audio feature value association information stored in the storage unit 11 in association with the language information. The learning module is as described above, and thus a description thereof will not be repeated.

In this manner, if a learning module is configured for each of the two or more pieces of language information, for example, it is possible to perform interpretation using a learning module corresponding to language information even in the case in which there is no interpreter corresponding to the language information.

Furthermore, evaluation time information is stored in the storage unit 11, and the evaluation acquiring unit 139 determines whether or not the current time acquired from a built-in clock or the like is the time indicated by the evaluation time information. If the current time is the time indicated by the evaluation time information, the evaluation acquiring unit 139 acquires, for each of the one or more interpreter identifiers, evaluation information using the two or more pieces of reaction information corresponding to the interpreter identifier. The evaluation information is as described above, and thus a description thereof will not be repeated. The processing unit 13 accumulates the acquired evaluation information, in the interpreter information group storage unit 112, in association with the interpreter identifier.

Accordingly, the evaluation values “Null” of the three pieces of interpreter information 1 to 3 excluding the interpreter information 4 having the interpreter identifier “translation engine”, among the interpreter information 1 to 4 constituting the interpreter information group corresponding to the place identifier “X”, are respectively updated to “4”, “5”, and “4”.

The processing that is performed by the information system A during the period in which the debate is held at the place Y, is as described above, and thus a description thereof has been omitted. The processing that is performed by the information system A during the period in which the seminar and the debate are simultaneously held is as described above, and thus a description thereof has been omitted.

As described above, with this embodiment, the interpretation system is an interpretation system realized by a server apparatus 1 and one or at least two terminal apparatuses 2, an interpreter information group, which is a group of one or more pieces of interpreter information, is stored in the interpreter information group storage unit 112, the information being information regarding an interpreter who interprets audio in a first language to a second language, and having a first language identifier for identifying the first language, a second language identifier for identifying the second language, and an interpreter identifier for identifying the interpreter, and a user information group, which is a group of one or more pieces of user information, is stored in the user information group storage unit 113, the information being information regarding users of one or more terminal apparatuses 2, and having a user identifier for identifying the user and a second language identifier for identifying a language used by the user for listening or reading.

The server apparatus 1 acquires one or more pieces of second language audio, which are data of audio obtained from audio in a first language spoken by one speaker, through interpretation performed by one or more interpreters respectively to second languages, and distributes, to each of the one or more terminal apparatuses 2, second language audio corresponding to the second language identifier contained in the user information corresponding to the terminal apparatus 2, out of the acquired one or more pieces of second language audio, using the user information group.

The one or more terminal apparatuses 2 receive second language audio distributed from the server apparatus 1, and reproduce the received second language audio.

Accordingly, it is possible to provide an interpretation system realized by a server apparatus 1 and one or more terminal apparatuses 2, and configured to distribute, to one or more users, one or more pieces of interpreted audio obtained from speech uttered by one speaker through interpretation performed by one or more interpreters, wherein the server apparatus 1 properly manages information regarding languages of one or more interpreters.

As a result, it is possible to provide various interpretation services using one or more interpreters. For example, it is possible to distribute, to each of the one or more terminal apparatuses 2, speech interpreted by an interpreter corresponding to a language used for listening or reading by the user of the terminal apparatus 2 in a seminar in which one speaker speaks, and to distribute, to the two or more terminal apparatuses 2, pieces of speech interpreted by one or more interpreters corresponding to languages used for listening or reading by the users of the terminal apparatuses 2 in an international conference in which two or more speakers have a debate.

Furthermore, a second aspect of the present invention is directed to the interpretation system according to the first aspect, wherein the server apparatus 1 acquires one or more pieces of second language text, which are data of text respectively obtained through speech recognition of the acquired one or more pieces of second language audio, and distributes, to the one or more terminal apparatuses 2, the acquired one or more pieces of second language text, and the terminal apparatuses 2 also receive the one or more pieces of second language text distributed from the server apparatus 1, and also output the one or more pieces of second language text.

Accordingly, it is possible to distribute not only pieces of speech interpreted by one or more interpreters, but also one or more pieces of text respectively obtained through speech recognition of the pieces of audio.

Furthermore, when resuming reproduction of second language audio after an interruption, the terminal apparatuses 2 performs chasing-reproduction of an un-reproduced portion in the second language audio, in fast-forward.

Accordingly, even when reproduction of speech interpreted by an interpreter is breaking up on the one or more terminal apparatuses 2, the users can listen to the un-reproduced portion without omission so as to make up for the delay.

Furthermore, the terminal apparatuses 2 performs chasing-reproduction of the un-reproduced portion in fast-forward at a speed corresponding to one or more of a delay time of the un-reproduced portion and a data size of the un-reproduced portion. Accordingly, it is easy to make up for the delay in fast-forward at a proper speed.

Furthermore, the terminal apparatuses 2 starts chasing-reproduction of an un-reproduced portion in response to a data size of the un-reproduced portion exceeding a predetermined threshold or reaching the threshold, and thus it is possible to make up for the delay while preventing the reproduction from being breaking up again.

Furthermore, the server apparatus 1 acquires first language text, which is data of text obtained through speech recognition of audio in the first language spoken by one speaker, acquires one or more translation results containing one or more pieces of data among translated text obtained through translation performed using a translation engine from the first language text to the second language and translation audio obtained through conversion from the translated text into audio, and further distributes, to each of the one or more terminal apparatuses 2, translation result corresponding to the second language identifier contained in the user information corresponding to the terminal apparatus 2, out of the acquired one or more translation results, using the user information group, and the terminal apparatus 2 also receives and reproduces the translation result distributed from the server apparatus 1. Accordingly, it is also possible for the users to use a translation result obtained by a translation engine.

In the above-described configuration, it is also possible that one or more pieces of speaker information are stored in the speaker information group storage unit 111, the speaker information having a speaker identifier for identifying a speaker and a first language identifier for identifying a first language in which the speaker speaks, and the server apparatus 1 acquires first language text corresponding to each of the one or more speakers, using the speaker information group.

Furthermore, the server apparatus 1 acquires only one or more translation results corresponding to one or more second language identifiers that are different from the one or more second language identifiers contained in the interpreter information group, and does not acquire one or more translation results corresponding to one or more second language identifiers that are the same as any of the one or more second language identifiers contained in the interpreter information group, among the one or more second language identifiers contained in the user information group, and thus it is possible to efficiently perform only necessary translation.

Furthermore, the terminal apparatuses 2 accepts an operation that chooses one or more data formats out of audio and text, and reproduces one or more pieces of data corresponding to the chosen one or more data formats, out of second language audio corresponding to the second language identifier contained in the user information regarding the user of the terminal apparatuses 2 and second language text obtained through speech recognition of the second language audio. Accordingly, it is possible for each user to use one or more of audio and text of a translator corresponding to his or her language.

Furthermore, the terminal apparatuses 2 also receives, in addition to the second language text, second language text in a secondary second language, which is another language, and outputs the received second language text and the second language text in the secondary second language.

Accordingly, it is possible for each user to also use text of an interpreter who is not an interpreter corresponding to his or her language.

In the above-described configuration, in the case in which at least text is chosen as the data format, the terminal apparatuses 2 can also accept an operation that further chooses a secondary second language identifier group, which is a group of one or more second language identifiers that are different from a primary second language identifier that is a second language identifier contained in the user information regarding the user of the terminal apparatuses 2, out of the two or more second language identifiers contained in the translator information group, and, in the case in which a secondary second language identifier group is chosen, the terminal apparatuses can also receive one or more pieces of second language text corresponding to the secondary second language identifier group from the server apparatus 1, and can output the one or more pieces of second language text corresponding to the secondary second language identifier group, together with the second language text corresponding to the primary second language identifier.

Furthermore, one or more interpreter information groups and one or more user information groups are respectively stored in the interpreter information group storage unit 112 and the user information group storage unit 113 in association with a place identifier for identifying a place, the user information further has a place identifier, and the second language audio acquiring unit 132 and the distributing unit 14 acquire and distribute one or more pieces of second language audio for each of two or more place identifiers. Accordingly, it is possible to acquire and distribute one or more pieces of second language audio for each of two or more places.

Furthermore, the server apparatus 1 acquires first language audio, which is data of audio in the first language spoken by one speaker, acquires audio feature value association information indicating association between feature values of first language audio and second language audio, using the acquired first language audio and the acquired one or more pieces of second language audio, for each of one or more pieces of language information, which are each a set of a first language identifier and a second language identifier, and configures a learning module in which the first language audio is taken as input and the second language audio is taken as output, for each of the one or more pieces of language information, using the audio feature value association information.

Accordingly, it is possible to interpret a first language to one or more second languages using a learning module.

Furthermore, the server apparatus 1 acquires reaction information, which is information regarding a reaction from the user to the second language audio reproduced by the reproducing unit 251, and configures a learning module, using audio feature value association information acquired from two or more sets of first language audio and second language audio selected using the reaction information.

In this manner, it is possible to select the audio feature value association information using a reaction from the user, thereby configuring a precise learning module.

Furthermore, the server apparatus 1 acquires reaction information, which is information regarding a reaction from the user to the second language audio reproduced by the terminal apparatuses 2, and acquires, for each of one or more interpreters, evaluation information regarding an evaluation of the interpreter, using the reaction information corresponding to the interpreter.

Accordingly, it is possible to evaluate one or more interpreters using a reaction from the user.

In this embodiment, the processing unit 13 determines whether or not there is an audio feature value association information that satisfies a predetermined condition, using the two or more pieces of reaction information stored in the storage unit 11 (S211), and, if there is audio feature value association information that satisfies a condition, the audio feature value association information is deleted (S212), but, instead of this configuration, it is also possible to apply a configuration in which it is determined whether or not the reaction information acquired by the reaction acquiring unit 137 satisfies a predetermined condition, for example, such as “one or more of a clapping sound or a nodding motion are detected”, wherein only second language audio corresponding to reaction information that satisfies the condition is accumulated in the storage unit 11, whereas second language audio corresponding to reaction information that does not satisfy the condition is not accumulated.

In this case, the flowchart in FIG. 2 is changed, for example, as follows.

The procedure after step S204 is changed so as to return to step S201, by deleting the two steps S205 and S206. Steps S211 and S212 are changed as follows.

(Step S211) The processing unit 13 determines whether or not the reaction information acquired in step S209 satisfies a predetermined condition. If the acquired reaction information satisfies a predetermined condition, the procedure advances to step S212, or otherwise the procedure advances to step S213.

(Step S212) The audio feature value association information acquiring unit 136 acquires audio feature value association information, using the first language audio acquired in step S201 and the second language audio corresponding to the reaction information determined as satisfying the condition in step S211.

Furthermore, new step S213 corresponding to the deleted step S206 is added after step S212.

(Step S213) The processing unit 13 accumulates the audio feature value association information acquired in step S112, in the storage unit 11, in association with language information, which is a set of the first language identifier and the second language identifier. Then, the procedure returns to step S201.

The processing in this embodiment may be realized by software. The software may be distributed by software downloads or the like. Furthermore, the software may be distributed in a form where the software is stored in a storage medium such as a CD-ROM.

The software that realizes the server apparatus 1 in this embodiment is, for example, the following sort of program. Specifically, this program is, for example, a program for causing a computer capable of accessing: an interpreter information group storage unit 112 in which an interpreter information group, which is a group of one or more pieces of interpreter information, is stored, the information being information regarding an interpreter who interprets audio in a first language to a second language, and having a first language identifier for identifying the first language, a second language identifier for identifying the second language, and an interpreter identifier for identifying the interpreter; and a user information group storage unit 113 in which a user information group, which is a group of one or more pieces of user information, is stored, the information being information regarding a user of each of the one or at least two terminal apparatuses 2, and having a user identifier for identifying the user and a second language identifier for identifying a language used by the user for listening or reading, to function as: a second language audio acquiring unit 132 that acquires one or more pieces of second language audio, which are data of audio obtained from audio in a first language spoken by one speaker, through interpretation performed by one or more interpreters respectively to second languages; and a distributing unit 14 that distributes, to each of the one or more terminal apparatuses 2, second language audio corresponding to the second language identifier contained in the user information corresponding to the terminal apparatus 2, out of the one or more pieces of second language audio acquired by the second language audio acquiring unit 132, using the user information group.

Furthermore, the software that realizes each of the terminal apparatuses 2 in this embodiment is, for example, the following sort of program. Specifically, this program is a program for causing a computer to function as: a terminal receiving unit 24 that receives the second language audio distributed by the distributing unit 14; and a reproducing unit 251 that reproduces the second language audio received by the terminal receiving unit 24.

Note that, although it was described in Embodiment 1 above that a first language identifier constituting speaker information (see FIG. 5), a first language identifier and a second language identifier constituting interpreter language information contained in interpreter information (see FIG. 6), and a primary second language identifier and a secondary second language identifier group constituting user language information contained in user information (see FIG. 7) are respectively stored in advance in the speaker information group storage unit 111, the interpreter information group storage unit 112, and the user information group storage unit 113, for example, they may be accumulated by the processing unit 13 or the like as will be described in the following modified example.

### Modified Example

In the modified example, in addition to the above-described various types of information, one or at least two pairs of interpretation language information and a set of a first language identifier for identifying a first language that is listened to by an interpreter and a second language identifier for identifying a second language that is spoken by the interpreter are stored in the storage unit 11 constituting the server apparatus 1. The interpretation language information is information indicating an interpretation language of an interpreter. The interpretation language is a type regarding a language of interpretation performed by an interpreter. The interpretation language information is, for example, an array of two language identifiers such as “jpn-eng” or “eng-jpn”, but may also be an ID such as “1” or “2” associated with the array, but there is no limitation on the form thereof.

The first language identifier is information for identifying a first language. The first language is a language that is listened to by an interpreter. The first language is also a language that is spoken by a speaker. The first language identifier is, for example, “jpn”, “eng”, or the like, but there is no limitation on the form thereof.

The second language identifier is information for identifying a second language. The second language is a language that is spoken by an interpreter. The second language is also a language that is listened to by a user. The second language identifier is, for example, “eng”, “jpn”, or the like, but there is no limitation on the form thereof.

Furthermore, screen configuring information is also stored in the storage section 11. The screen configuring information is information for configuring a screen. The screen is, for example, a later-described interpreter setting screen, a later-described user setting screen, or the like, but there is no limitation on the type thereof. The screen configuring information is, for example, HTML, XML, a program, or the like, but there is no limitation on the form thereof.

The screen configuring information has, for example, an image, a text, layout information, and the like. The image is, for example, an image of a later-described “set” button, a chart, a dialog box, or the like. The text is, for example, a dialog such as “Please select a speaker.”, a text associated with a button, or the like. The layout information is information indicating the arrangement of an image or a text on a screen. There is no limitation on the data structure of the screen configuring information.

The processing unit 13 and the like perform, for example, the following operations in addition to the various operations described in Embodiment 1.

In response to transmission of interpreter setting screen information from the distributing unit 14, the receiving unit 12 receives a setting result in a pair with an interpreter identifier, from each of one or more speaker apparatuses 4. The setting result is information regarding a result of settings regarding a language. The setting result received in a pair with an interpreter identifier contains interpretation language information. The setting result received in a pair with an interpreter identifier typically contains a speaker identifier as well.

Alternatively, for example, if the number of speakers who speak at one place is only one and a pair of a place identifier for identifying the one place and a speaker identifier for identifying the one speaker is stored in the storage unit 11, the setting result that is received in a pair with an interpreter identifier may contain a place identifier instead of a speaker identifier, and there is no limitation on the structure thereof.

Furthermore, in response to transmission of user setting screen information from the distributing unit 14, the receiving unit 12 receives a setting result in a pair with a user identifier, from each of one or more terminal apparatuses 2. The setting result that is received in a pair with a user identifier contains a primary second language identifier. The setting result that is received in a pair with a user identifier may contain, for example, a secondary second language identifier group. Furthermore, the setting result that is received in a pair with a user identifier may contain, for example, a speaker identifier, and there is no limitation on the structure thereof. The receiving unit 12 may receive, for example, a setting result and a place identifier in a pair with a user identifier.

The processing unit 13 performs language setting processing, using the setting result received by the receiving unit 12. The language setting processing is processing that performs various types of settings regarding a language. The various types of settings are typically settings of an interpretation language of the interpreter and settings of a language of a speaker. The various types of settings may include, for example, settings of a language of a user as well.

The processing that sets an interpretation language of the interpreter is accumulating a set of a first language identifier and a second language identifier in association with an interpreter identifier. The set of a first language identifier and a second language identifier is typically accumulated in the interpreter information group storage unit 112 in association with an interpreter identifier, but there is no limitation on where the information is accumulated.

The processing that sets a language of a speaker is accumulating a first language identifier accumulated in association with an interpreter identifier, in association with a speaker identifier. The first language identifier is typically accumulated in the speaker information group storage unit 111 in association with a speaker identifier, but there is no limitation on where the information is accumulated.

The processing that sets a language of a user is accumulating a primary second language identifier corresponding to one second language identifier, among the one or at least two second language identifiers accumulated in association with an interpreter identifier or a place identifier, in association with a user identifier. In the settings of a language of a user, for example, a secondary second language identifier group corresponding to the one second language identifier may also be accumulated in association with a user identifier.

Furthermore, in the settings of a language of a user, for example, the output mode of a second language may also be accumulated in association with a user identifier. The output mode of a second language is typically the mode of either audio or text. In this modified example, typically, it is set whether the primary second language is to be output in the audio mode (hereinafter, audio output) or to be output in the text mode (hereinafter, text output). Note that it is also possible to set whether each secondary second language constituting a secondary second language group is to be output in either the audio mode or the text mode.

More specifically, the processing unit 13 includes, for example, a language setting unit 130a (not shown) and a screen information configuring unit 130b (not shown). The language setting unit 130a performs the above-described language setting processing.

For example, the screen information configuring unit 130b configures interpreter setting screen information, using the screen configuring information stored in the storage unit 11. The interpreter setting screen information is information of an interpreter setting screen. The interpreter setting screen a screen on which an interpreter sets an interpretation language and the like. The interpreter setting screen has, for example, a constituent element for allowing an interpreter to select an interpretation language out of predetermined one or at least two interpretation languages. It is preferable that the interpreter setting screen also has, for example, a constituent element for allowing an interpreter to select one speaker out of one or at least two speakers. Furthermore, the interpreter setting screen may also have, for example, a constituent element for instructing a computer to set an interpretation language and the like selected by an interpreter. The constituent element is, for example, a chart, a button, or the like, but there is no limitation on the type thereof.

The interpreter setting screen specifically contains, for example, a dialog such as “Please select a speaker.” or “Please select an interpretation language.”, a chart for selecting an interpretation language and the like, a “set” button for setting a selection result, and the like, but there is no limitation on the structure thereof. The interpreter setting screen information is information describing such an interpreter setting screen, for example, in HTML or other formats. The configured interpreter setting screen information is transmitted via the distributing unit 13 to each of one or more interpreter apparatuses 4.

If the receiving unit 12 receives a setting result in a pair with an interpreter identifier, the language setting unit 130a accumulates a first language identifier and a second language identifier corresponding to the interpretation language information contained in the received setting result, in the interpreter information group storage unit 112, in association with the received interpreter identifier.

Furthermore, the language setting unit 130a accumulates the same first language identifier as that accumulated in the interpreter information group storage unit 112, in the speaker information group storage unit 111, in association with a speaker identifier contained in the received setting result.

Furthermore, the language setting unit 130a accumulates the same second language identifier as that accumulated in the interpreter information group storage unit 112, in the storage unit 11, in association with a place identifier corresponding to a speaker identifier contained in the received setting result.

The above-described processing (which may be hereinafter referred to as “interpreter/speaker language setting processing”) is performed for each of one or more interpreters, so that one or at least two first language identifiers are stored in the speaker information storage unit 111, in association with a speaker identifier. Also, one or at least two sets of a first language identifier and a second language identifier are stored in the interpreter information storage unit 112, in association with an interpreter identifier. Furthermore, one or at least two second language identifiers (which may be hereinafter referred to as “second language identifier group”) are stored in the storage unit 11, in association with an interpreter identifier or a place identifier.

Subsequently, the language setting unit 130a acquires one place identifier out of one or more place identifiers stored in the speaker information group storage unit 111 or the like. The screen information configuring unit 130b configures user language setting screen information, using a second language identifier group corresponding to the acquired place identifier out of the one or more second language identifier groups stored in the storage unit 11, and the screen configuring information stored in the storage unit 11.

The user language setting screen information is information of a user language setting screen. The user setting screen is a screen on which a user sets a language and the like. The user setting screen has, for example, a constituent element for allowing a user to select one primary second language out of one or at least two primary second languages. It is preferable that the user setting screen also has, for example, a constituent element for allowing a user to select one or at least two secondary second languages out of one or at least two secondary second languages corresponding to one or at least two second language identifiers stored in the storage unit 11 in association with an interpreter identifier or a place identifier. Furthermore, the user setting screen may also have, for example, a constituent element for instructing a computer to set a primary second language and the like selected by a user.

The interpreter setting screen specifically contains, for example, a dialog such as “Please select a primary language.” or “Please select a secondary language group”, a chart for selecting a primary language and the like, a “set” button for setting a selection result, and the like, but there is no limitation on the structure thereof. The user setting screen information is information describing such a user setting screen, for example, in HTML or other formats.

The configured user language setting screen information is transmitted by the distributing unit 14 to each of one or more terminal apparatuses 2. In response to the transmission, a setting result is transmitted in a pair with a user identifier to the server apparatus 1 from each of one or more terminal apparatuses 2. A place identifier may also be transmitted together with the setting result and the like from each terminal apparatus 2.

When the receiving unit 12 receives a setting result in a pair with a user identifier, the language setting unit 130a accumulates a primary second language identifier, a secondary second language identifier group, and data format information contained in the received setting result, in the user information group storage unit 113, in association with a set of a place identifier that is paired with a speaker identifier contained in the received setting result, and the received user identifier. The place identifier that is paired with a speaker identifier is acquired, for example, from the interpreter information group storage unit 111 or the like.

If the receiving unit 12 also receives a place identifier together with the setting result and the like, it is sufficient that the language setting unit 130a accumulates a primary second language identifier, a secondary second language identifier group, and data format information contained in the received setting result, in the user information group storage unit 113, in association with a set of the received place identifier and the received user identifier.

The above-described processing (which may be hereinafter referred to as “user language setting processing”) is performed for each of one or more places, so that a second language identifier is stored in the user information storage unit 113, in association with a set of a place identifier and a user identifier.

The distributing unit 14 transmits the interpreter setting screen information configured by the screen information configuring unit 130b, to each of one or more interpreter apparatuses 4.

Furthermore, the distributing unit 14 transmits the user setting screen information configured by the screen information configuring unit 130b, to each of one or more terminal apparatuses 2.

The terminal apparatus 2 performs, for example, the following operations in addition to the operations described in Embodiment 1. That is to say, the terminal apparatus 2 receives user setting screen information from the server apparatus 1, configures a user setting screen using the received user setting screen information, outputs the configured user setting screen, accepts a setting result of a user to the output user setting screen, and transmits the accepted setting result in a pair with the user identifier to the server apparatus 1.

More specifically, the user identifier is stored in the user information storage unit 211 as described above. Although not shown in FIG. 1, the terminal apparatus 2 includes a terminal output unit 26.

The terminal accepting unit 22 accepts various types of information. The various types of information are, for example, a setting result. For example, the terminal accepting unit 22 accepts a setting result set by a user on a user setting screen displayed on a display screen, via an input device such as a touch panel.

For example, the terminal accepting unit 22 may also accept a place identifier via an input device. Alternatively, for example, a transmitting apparatus (not shown) such as a wireless LAN access point installed at a place may regularly or irregularly transmit a place identifier for identifying the place, and, for example, the processing unit 13 may receive the place identifier transmitted from the transmitting apparatus, via the receiving unit 12.

The terminal transmitting unit 23 transmits various types of information. The various types of information are, for example, a setting result. For example, the terminal transmitting unit 23 transmits a setting result accepted by the terminal accepting unit 22, in a pair with a user identifier stored in the user information storage unit 211, to the server apparatus 1.

For example, the terminal transmitting unit 23 may also transmit a place identifier accepted by the terminal accepting unit 22 together with the setting result and the like.

The terminal receiving unit 24 receives various types of information. The various types of information are, for example, user setting screen information. For example, the terminal receiving unit 24 receives user setting screen information from the server apparatus 1.

The terminal processing unit 25 performs various types of processing. The various types of processing are, for example, determining whether or not the terminal receiving unit 24 has received user setting screen information from the server apparatus 1, conversion of an accepted setting result into a setting result that is to be transmitted, or the like.

The terminal output unit 26 outputs various types of information. The various types of information are, for example, a user setting screen. For example, the terminal output unit 26 outputs the user setting screen configured by the terminal processing unit 25, via an output device such as a display screen, using the user setting screen information received by the terminal receiving unit 24 from the server apparatus 1.

The speaker apparatus 3 does not have to additionally perform any special operations.

The interpreter apparatus 4 performs, for example, the following operations in addition to the operations described in Embodiment 1. That is to say, the interpreter apparatus 4 receives an interpreter setting screen from the server apparatus 1, outputs the received interpreter setting screen, accepts a setting result of an interpreter to the output interpreter setting screen, and transmits the accepted setting result in a pair with the interpreter identifier to the server apparatus 1.

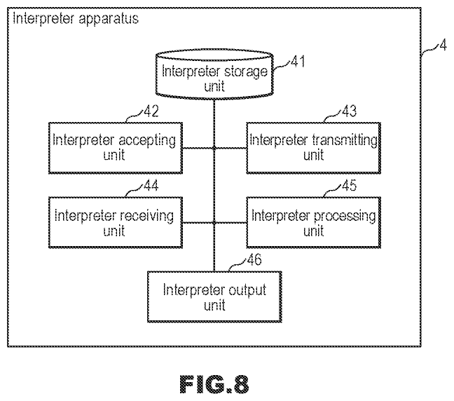

More specifically, for example, the units shown in FIG. 8 perform the following operations. FIG. 8 is a block diagram of the interpreter apparatus 4 according to the modified example. The interpreter apparatus 4 includes an interpreter storage unit 41, an interpreter accepting unit 42, an interpreter transmitting unit 43, an interpreter receiving unit 44, an interpreter processing unit 45, and an interpreter output unit 46.

Information such as an interpreter identifier is stored in the interpreter storage unit 41.

The interpreter accepting unit 42 accepts various types of information. The various types of information are, for example, a setting result. For example, the interpreter accepting unit 42 accepts a setting result set by an interpreter to an interpreter setting screen displayed on a display screen, via an input device such as a touch panel.

The interpreter transmitting unit 43 transmits various types of information. The various types of information are, for example, a setting result. For example, the interpreter transmitting unit 43 transmits a setting result accepted by the interpreter accepting unit 42, in a pair with an interpreter identifier stored in the interpreter storage unit 41, to the server apparatus 1.

The interpreter receiving unit 44 receives various types of information. The various types of information are, for example, interpreter setting screen information. For example, the interpreter receiving unit 44 receives interpreter setting screen information from the server apparatus 1.

The interpreter processing unit 45 performs various types of processing. The various types of processing are, for example, determining whether or not the interpreter accepting unit 42 has accepted information such as setting result and the like, conversion of accepted information into information that is to be transmitted, or the like.

The interpreter output unit 46 outputs various types of information. The various types of information are, for example, interpreter setting screen information. For example, the interpreter output unit 46 outputs an interpreter setting screen configured by the interpreter processing unit 45 using interpreter setting screen information received by the interpreter receiving unit 44, via an output device such as a display screen.

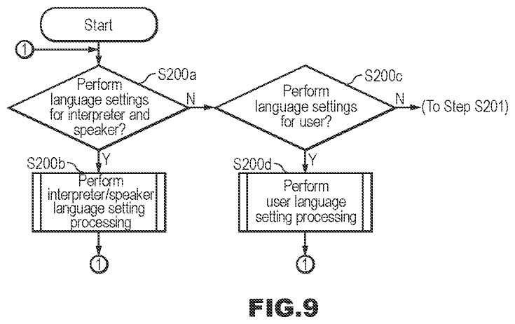

The flowchart of the server apparatus 1 in the modified example is realized, for example, by adding four steps S200a to S200d shown in FIG. 9 to the flowcharts shown in FIGS. 2 and 3. FIG. 9 is a flowchart illustrating language setting processing, which is added to the flowcharts in FIGS. 2 and 3, in the modified example.

(Step S200a) The processing unit 13 determines whether or not to perform language settings for an interpreter and a speaker. For example, after the server apparatus 1 is turned on and the startup of the program is completed, the processing unit 13 may determine to perform language settings for an interpreter and the like. If it is determined that language settings for an interpreter and the like are to be performed, the procedure advances to step S200b, or otherwise the procedure advances to step S200c.

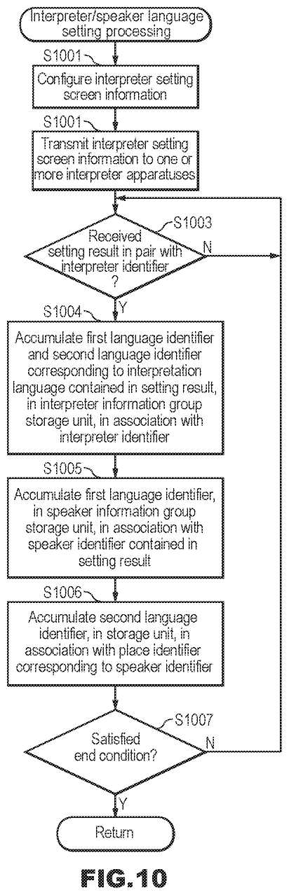

(Step S200b) The language setting unit 130a performs interpreter/speaker language setting processing. The interpreter/speaker language setting processing will be described with reference to the flowchart in FIG. 10.

(Step S200c) The processing unit 13 determines whether or not to perform language settings for a user. For example, in response to the completion of the interpreter/speaker language setting processing in step S200b the processing unit 13 may determine to perform language settings for a user. If it is determined that language settings for a user are to be performed, the procedure advances to step S200d, or otherwise the procedure advances to step S201 (see FIG. 2).

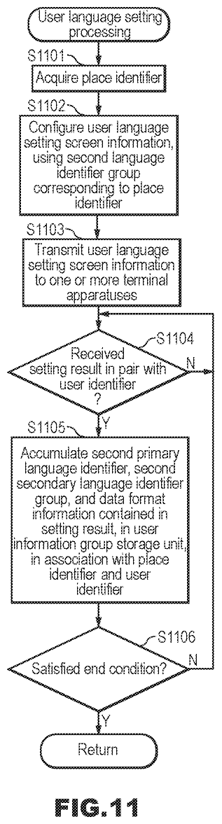

(Step S200d) The language setting unit 130a performs user language setting processing. The user language setting processing will be described with reference to the flowchart in FIG. 11.

In this modified example, the procedure after each of the seven steps S202, S206, S208, S210, S211, S214, and S217 shown in FIGS. 2 and 3, and in the case of NO in S215 returns to step S200a in FIG. 9.

FIG. 10 is a flowchart illustrating interpreter/speaker language setting processing.

(Step S1001) The screen information configuring unit 130b configures interpreter setting screen information, using the screen configuring information stored in the storage unit 11.

(Step S1002) The distributing unit 14 transmits the interpreter setting screen information configured in step S1001, to each of one or more interpreter apparatuses 4.

(Step S1003) The processing unit 13 determines whether or not the receiving unit 12 has received a setting result in a pair with an interpreter identifier. If it is determined that the receiving unit 12 has received a setting result in a pair with an interpreter identifier, the procedure advances to step S1004, or otherwise the procedure returns to step S1003.

(Step S1004) The language setting unit 130a accumulates a first language identifier and a second language identifier corresponding to the interpretation language information contained in the setting result received in step S1003, in the interpreter information group storage unit 112, in association with the interpreter identifier received in step S1003.

(Step S1005) The language setting unit 130a accumulates the same first language identifier as that accumulated in the interpreter information group storage unit 112 in step S1004, in the speaker information group storage unit 111, in association with a speaker identifier contained in the setting result received in step S1003.

(Step S1006) The language setting unit 130a accumulates the same second language identifier as that accumulated in the interpreter information group storage unit 112 in step S1004, in the storage unit 11, in association with a place identifier corresponding to a speaker identifier contained in the setting result received in step S1003.

(Step S1007) The processing unit 13 determines whether or not an end condition has been satisfied. The end condition may be, for example, “a setting result has been received from all of one or more interpreter apparatuses 4 to which the interpreter setting screen information was transmitted”, or “the elapsed time from transmission of the interpreter setting screen information is at a threshold or more or is more than the threshold”.

If it is determined that the end condition has been satisfied, the procedure returns to the upper-level processing, or otherwise the procedure returns to step S1003.

In the flowchart in FIG. 10, after step S1006 is repeatedly performed, one or at least two second language identifier groups are stored in the storage unit 11 in association with a place identifier.

FIG. 11 is a flowchart illustrating user language setting processing. The flowchart in FIG. 11 is a flowchart regarding a place that is identified with one place identifier out of one or more place identifiers stored in the speaker information group storage unit 111 or the like, and is performed for each of one or more places identifier.

(Step S1101) The processing unit 13 acquires one place identifier out of one or more place identifiers stored in the speaker information group storage unit 111 or the like.

(Step S1102) The screen information configuring unit 130b configures user language setting screen information, using a second language identifier group corresponding to the place identifier acquired in step S1101 out of one or more second language identifier groups stored in the storage unit 11, and the screen configuring information stored in the storage unit 11.

(Step S1103) The distributing unit 14 transmits the user language setting screen information configured in step S1102, to each of one or more terminal apparatuses 2.

(Step S1104) The processing unit 13 determines whether or not the receiving unit has received a setting result in a pair with a user identifier. If it is determined that the receiving unit 12 has received a setting result in a pair with a user identifier, the procedure advances to step S1105, or otherwise the procedure returns to step S1104.

(Step S1105) The language setting unit 130a accumulates a primary second language identifier, a secondary second language identifier group, and data format information contained in the setting result received in step S1104, in the user information group storage unit 113, in association with a place identifier that is paired with a speaker identifier contained in the setting result, and the user identifier received in step S1104.

(Step S1106) The processing unit 13 determines whether or not an end condition has been satisfied. The end condition may be, for example, “a setting result has been received from all of one or more terminal apparatuses 2 to which the user setting screen information was transmitted”, or “the elapsed time from transmission of the user setting screen information is at a threshold or more or is more than the threshold”.

If it is determined that the end condition has been satisfied, the procedure returns to the upper-level processing, or otherwise the procedure returns to step S1104.

Hereinafter, a specific example in the modified example will be described. In this specific example, it is assumed that Japanese in which a speaker a speaks at a place X is interpreted by two interpreters A and B to English and Chinese respectively.

When the server apparatus 1 is turned on and the startup of the program is completed, the screen information configuring unit 130b configures interpreter setting screen information, using the screen configuring information stored in the storage unit 11, the distributing unit 14 transmits the configured interpreter setting screen information to each of two or more interpreter apparatuses 4.

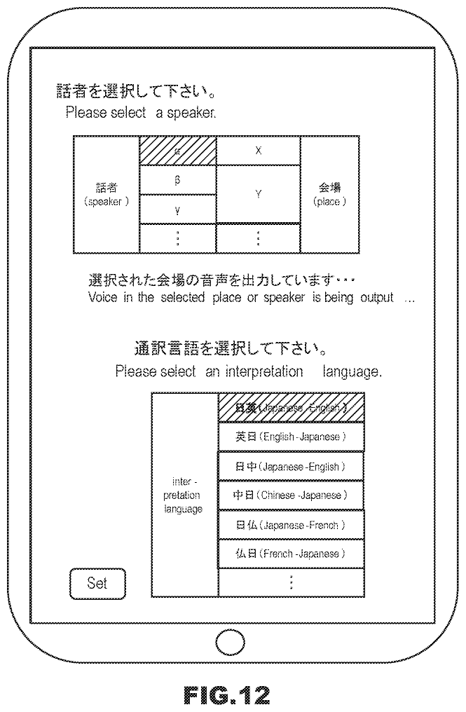

An interpreter apparatus 4A, which is an apparatus of the interpreter A, out of the two or more interpreter apparatuses 4 receives the interpreter setting screen information, configures interpreter setting screen using the received interpreter setting screen information, and outputs the configured interpreter setting screen via a display screen. Accordingly, the display screen of the interpreter apparatus 4A displays, for example, an interpreter setting screen as shown in FIG. 12.

FIG. 12 is a diagram showing an example of an interpreter setting screen. The interpreter setting screen contains, for example, a set of a dialog such as “Please select a speaker.” and a chart for selecting a speaker, a set of a dialog such as “Please select an interpretation language.” and a chart for selecting an interpretation language and the like, a “set” button for setting a selection result, and the like.

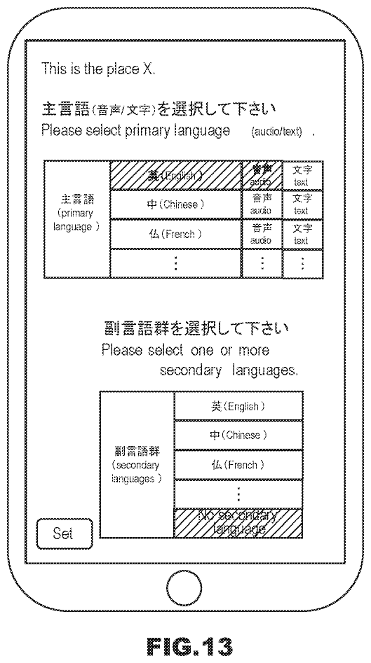

Each dialog on the interpreter setting screen is displayed in multiple languages. The multiple languages are a language group corresponding to a second language identifier group. The same applies to dialogs on a later-described user setting screen (see FIG. 13).

The interpreter A selects “a” as the speaker and “jpn-eng” as the interpretation language on the interpreter setting screen on the display screen, and then presses the set button.

In response to the selection, the speaker apparatus 4A acquires a setting result “(a, jpn-eng)” having the interpreter identifier “a” and the interpretation language information “jpn-eng”, and transmits the acquired setting result in a pair with the interpreter identifier “A” to the server apparatus 1.

In the server apparatus 1, the receiving unit 12 receives the setting result “(a, jpn-eng)” in a pair with the interpreter identifier “A”, and the language setting unit 130a updates the first language identifier “Null” and the second language identifier “Null” to “jpn” and “eng” respectively, the first language identifier “Null” and the second language identifier “Null” constituting interpreter language information that is contained in any of the two or more pieces of interpreter information stored in the interpreter information group storage unit 112 and that is paired with the received interpreter identifier “A”.

Furthermore, the language setting unit 130a updates the first language identifier “Null” to “jpn”, the first language identifier “Null” being contained in speaker information 1 containing the speaker identifier “a” contained in the received setting result out of the one or more pieces of speaker information stored in the speaker information group storage unit 111.

Furthermore, the language setting unit 130a updates the first language identifier “Null” to the first language identifier “jpn” contained in the received setting result, the first language identifier “Null” being a first language identifier that is contained in any of the one or more pieces of speaker information stored in the interpreter information group storage unit 112 and that is paired with the speaker identifier “a” contained in the received setting result.

The interpreter/speaker language setting processing as described above is also performed on the other interpreter B, so that a first language identifier “Null” and a second language identifier “Null” constituting interpreter language information that is paired with the interpreter identifier “B” are updated to “jpn” and “chi” respectively.

Through the above-described procedure, language settings for a speaker a who speaks at a place X and two interpreters A and B who interpret speech of the speaker a are completed. The screen information configuring unit 130b configures user setting screen information using two second language identifiers stored in the storage unit 11 in association with the place identifier “X”, and the screen configuring information stored in the storage unit 11, and the distributing unit 14 distributes the information to each of one or more terminal apparatuses 2.

The terminal apparatus 2 of a user a (hereinafter, a terminal apparatus 2a) receives the user setting screen information, configures a user setting screen using the received user setting screen information, and outputs the configured user setting screen via a display screen. Accordingly the display screen of the terminal apparatus 2a displays, for example, a user setting screen as shown in FIG. 13.

FIG. 13 is a diagram showing an example of a user setting screen. The user setting screen contains, for example, a set of a dialog such as “This is the place X. Please select a primary language (audio/text).” and a chart for selecting a primary language and the like, a set of a dialog such as “Please select one or more secondary languages.” and a chart for selecting a secondary language group, a “set” button for setting a selection result, and the like.

The user a selects “eng” as the primary language, “audio” as the output mode of the primary language, and “No secondary language” as the output mode of the secondary language group on the user setting screen on the display screen, and then presses the set button.

The terminal apparatus 2a acquires a setting result “(a, eng, Null, audio)” having the speaker identifier “a”, the primary second language identifier “eng”, the secondary second secondary language identifier group “Null”, and the data format information “audio”, and transmits the acquired setting result in a pair with the user identifier “a” to the server apparatus 1.

In the server apparatus 1, the receiving unit 12 receives the setting result “(a, eng, Null, audio)” in a pair with the user identifier “a”, and the language setting unit 130a acquires a primary second language identifier “eng”, a secondary second language identifier group “Null”, and data format information “audio” from the received setting result “(a, eng, Null)”.

Then, the language setting unit 130a updates the primary second language identifier “Null”, the secondary second language identifier group “Null”, and the data format information “Null” to “eng”, “Null”, and “audio” respectively, the primary second language identifier “Null”, the secondary second language identifier group “Null”, and the data format information “Null” being contained in the user information 1 that is paired with the received user identifier “a”, out of the two or more pieces of user information in the user information group storage unit 113.

Accordingly, the user language information associated with the set of the place identifier “X” and the user identifier “a” is as shown in FIG. 7.

The user language setting processing as described above is also performed on the other users b to d corresponding to the place X, so that the user language information of each user is as shown in FIG. 7.

As is clear from the description above, in this modified example, one or at least two pairs of interpretation language information indicating an interpretation language representing a type regarding a language of interpretation performed by an interpreter, and a set of a first language identifier for identifying a first language that is listened to by the interpreter and a second language identifier for identifying a second language that is spoken by the interpreter are stored in the storage unit 11, and the server apparatus 1 receives a setting result having interpretation language information regarding an interpretation language of the interpreter, in a pair with an interpreter identifier for identifying the interpreter, from an interpreter apparatus 4 serving as a terminal apparatus of an interpreter acquires a set of a first language identifier and a second language identifier that is paired with the interpretation language information contained in the setting result, from the storage unit 11, accumulates the first language identifier and the second language identifier constituting the acquired set, in association with the interpreter identifier, and accumulates the first language identifier constituting the acquired set, in association with a speaker identifier for identifying a speaker subjected to interpretation by an interpreter, and thus it is possible to properly set an interpretation language of each of one or more interpreters and a language of a speaker corresponding to an interpreter.

Furthermore, the server apparatus 1 transmits interpreter setting screen information, which is information of a screen on which an interpreter sets one speaker out of one or more speakers and one interpretation language out of one or more interpretation languages, to an interpreter apparatus 4 of each of one or more interpreters, and the receiving unit 12 receives a setting result further containing a speaker identifier for identifying a speaker subjected to interpretation by an interpreter, in a pair with an interpreter identifier for identifying the interpreter, from the interpreter apparatus 4 of each of the one or more interpreters, and thus it is possible to easily and properly set an interpretation language of each of one or more interpreters and a language of a speaker corresponding to an interpreter.

Furthermore, the server apparatus 1 accumulates a second language identifier constituting the acquired set, in the storage unit 11, transmits user setting screen, which is information of a screen on which a user at least sets a primary second language corresponding to one second language identifier out of one or more second language identifiers stored in the storage unit 11, to a terminal apparatus 2 of each of one or more users, receives a setting result at least containing a primary second language identifier for identifying a primary second language set by a user, in a pair with a user identifier for identifying the user, from the terminal apparatus 2 of each of the one or more users and accumulates at least the primary second language identifier contained in the setting result, in association with the user identifier, and thus it is also possible to properly set a language of each of one or more users.

The program that realizes the server apparatus 1 in this modified example is, for example, the following sort of program. Specifically, this program is a program for causing a computer capable of accessing a storage unit in which one or at least two pairs of interpretation language information indicating an interpretation language representing a type regarding a language of interpretation performed by an interpreter, and a set of a first language identifier for identifying a first language that is listened to by the interpreter and a second language identifier for identifying a second language that is spoken by the interpreter are stored, to function as: a receiving unit 12 that receives a setting result having interpretation language information regarding an interpretation language of an interpreter, from an interpreter apparatus serving as a terminal apparatus of the interpreter, in a pair with an interpreter identifier for identifying the interpreter; and a language setting unit 130a that acquires a set of a first language identifier and a second language identifier that is paired with the interpretation language information contained in the setting result, from a storage unit 11, accumulates the first language identifier and the second language identifier constituting the acquired set, in association with the interpreter identifier, and accumulates the first language identifier constituting the acquired set, in association with an interpreter identifier for identifying a speaker subjected to interpretation by the interpreter.

### Embodiment 2

Hereinafter, an embodiment of an audio processing apparatus and the like will be described with reference to the drawings. It should be noted that constituent elements denoted by the same reference numerals in the embodiments perform similar operations, and thus a description thereof may not be repeated.

The audio processing apparatus in this embodiment is, for example, a server. The server is, for example, a server in an organization such as a company or association that provides simultaneous interpretation service. Alternatively, the server may be, for example, a cloud server, an ASP server, or the like, and there is no limitation on the type or location thereof. For example, the audio processing apparatus is communicably connected to each of one or at least two first terminals (not shown) and one or at least two second terminals (not shown) via a network such as an LAN or the Internet, a wireless or wired communication line, or the like.

The first terminal is a terminal of a later-described first speaker. The first terminal accepts audio of speech uttered by a first speaker, and transmits it to the audio processing apparatus. The second terminal is a terminal of a later-described first speaker. The second terminal accepts audio and transmits it to the audio processing apparatus. The first terminal and the second terminal are, for example, mobile terminals, but may also be desktop terminals or microphones, and there is no limitation on the type thereof. The mobile terminals are portable terminals. Examples of the mobile terminals include smartphones, tablet devices, mobile phones, and laptop PCs, but there is no limitation on the type thereof.

Furthermore, the audio processing apparatus may also be communicable with other terminals. The other terminals are, for example, terminals in an organization or the like, but there is no limitation on the type or location thereof.

The audio processing apparatus may be, for example, a stand-alone terminal, and may be realized by any apparatus.

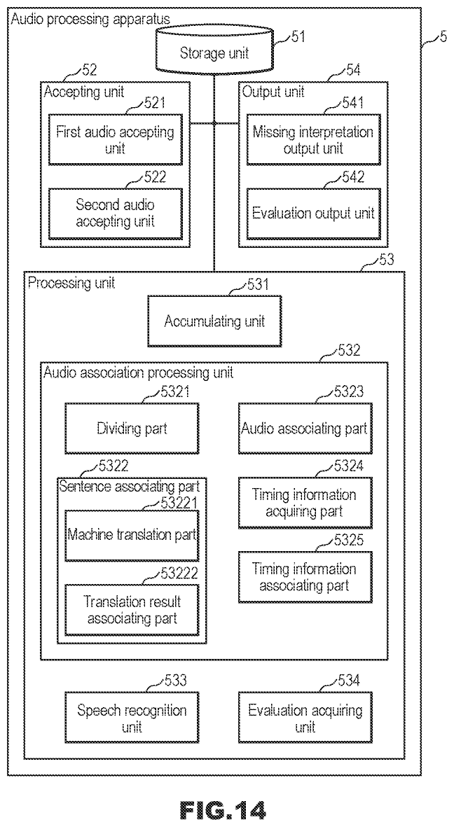

FIG. 14 is a block diagram of an audio processing apparatus 5 in this embodiment. The audio processing apparatus 5 includes a storage unit 51, an accepting unit 52, a processing unit 53, and an output unit 54. The accepting unit 52 includes a first audio accepting unit 521 and a second audio accepting unit 522. The processing unit 53 includes an accumulating unit 531, an audio association processing unit 532, a speech recognition unit 533, and an evaluation acquiring unit 534. The audio association processing unit 532 includes a dividing part 5321, a sentence associating part 5322, an audio associating part 5323, a timing information acquiring part 5324, and a timing information associating part 5325. The sentence associating part 5322 includes a machine translation part 53221 and a translation result associating part 53222. The output unit 54 includes a missing interpretation output unit 541 and an evaluation output unit 542.

Various types of information may be stored in the storage unit 51 constituting the audio processing apparatus. The various types of information are, for example, first audio, second audio, first audio segment, a second audio segment, a first sentence block, a second sentence block, a first sentence, a second sentence, a machine translation result of a first sentence, first timing information, second timing information, or the like. These types of information will be described later.

Furthermore, typically, one or at least two pieces of first speaker information and one or at least two pieces of second speaker information are also stored in the storage unit 51. The first speaker information is information regarding a first speaker. The first speaker information typically has a first speaker identifier. The first speaker identifier is information for identifying a first speaker. The first speaker identifier is, for example, an e-mail address, a telephone number, an ID, or the like, but may also be a terminal identifier (e.g., a MAC address, an IP address, etc.) for identifying a first terminal of a first speaker, and any information is possible as long as a first speaker can be identified. For example, if the number of first speakers is only one, the first speaker information does not have to have a first speaker identifier.

The second speaker information is information regarding a second speaker. The second speaker information typically has a second speaker identifier. The second speaker identifier is information for identifying a second speaker. The second speaker identifier is, for example, an e-mail address, a telephone number, an ID, or the like, but may also be a terminal identifier (e.g., a MAC address, an IP address, etc.) for identifying a second terminal of a second speaker, and any information is possible as long as a second speaker can be identified. For example, if the number of second speakers is only one, the second speaker information does not have to have a second speaker identifier. The second speaker information may have, for example, a later-described evaluation information.

Furthermore, for example, one or at least two pieces of set information may also be stored in the storage unit 51. The set information is information regarding a set of a first speaker and a second speaker. The set information has, for example, a first speaker identifier and a second speaker identifier. For example, if the number of sets of a first speaker and a second speaker is only one, set information does not have to be stored in the storage unit 51.

The accepting unit 52 accepts various types of information. The various types of information are, for example, later-described first audio, later-described second audio, an instruction to output later-described evaluation information, or the like.

The accepting unit 52 receives information such as first audio, for example, from a terminal such as a first terminal, but may also accept information via an input device such as a microphone in the audio processing apparatus.

The first audio accepting unit 521 accepts first audio. The first audio is audio of speech uttered by a first speaker. The first speaker is a speaker who speaks in a first language. The first language can be said to be a language that is spoken by a first speaker. The first language is, for example, Japanese, but there is no limitation on the language, and examples thereof include English, Chinese, and French. The speech is, for example, a lecture, but may also be a bidirectional speech such as a debate or a conversation, and there is no limitation on the type thereof. The first speaker is specifically, for example, a lecturer, but may also be a debater, a person having a conversation, or the like.

The first audio accepting unit 521 receives first audio of speech uttered by the first speaker in a pair with a first speaker identifier for identifying the first speaker, for example, from the first terminal of the first speaker, but may also accept it via a first microphone in the audio processing apparatus. The first microphone is a microphone for capturing the first audio of speech uttered by the first speaker. The receiving the first audio in a pair with the first speaker identifier is, for example, receiving the first audio after receiving the first speaker identifier, but may also be receiving the first speaker identifier during receiving the first audio, or receiving the first speaker identifier after receiving the first audio.

The second audio accepting unit 522 accepts second audio. The second audio is audio obtained through simultaneous interpretation of the first audio of speech uttered by the first speaker into a second language by a second speaker. The second speaker is a person who performs simultaneous interpretation of speech of the first speaker, and can be said to be a simultaneous interpreter. The simultaneous interpretation is an act of performing interpretation almost simultaneously with listening to speech of a first speaker. In simultaneous interpretation, the smaller the delay of the second audio relative to the first audio, the better, but the delay may be partially large, and there is no limitation on the delay time. The delay will be described later.

The second audio accepting unit 522 receives second audio obtained by the second speaker in a pair with a second speaker identifier for identifying the second speaker, for example, from the second terminal of the second speaker, but may also accept it via a second microphone in the audio processing apparatus. The second microphone is a microphone for capturing the second audio obtained by the second speaker. The receiving the second audio in a pair with the second speaker identifier is, for example, receiving the second audio after receiving the second speaker identifier, but may also be receiving the second speaker identifier during receiving the second audio, or receiving the second speaker identifier after receiving the second audio.

The processing unit 53 performs various types of processing. The various types of processing are, for example, processing performed by the accumulating unit 531, the audio association processing unit 532, the speech recognition unit 533, the evaluation acquiring unit 534, the dividing part 5321, the sentence associating part 5322, the audio associating part 5323, the timing information acquiring part 5324, the timing information associating part 5325, the machine translation part 53221, the translation result associating part 53222 and the like. The processing unit 53 also performs various types of determination and the like described with reference to the flowcharts.

The accumulating unit 531 accumulates various types of information. The various types of information are, for example, first audio, second audio, a first audio segment, a second audio segment, a first sentence block, a second sentence block, a first sentence, a second sentence, or the like. A first audio segment, a second audio segment, a first sentence block, a second sentence block, a first sentence, and a second sentence will be described later. The operation in which the accumulating unit 531 accumulates these types of information will be described as appropriate.

The accumulating unit 531 accumulates information such as the first audio accepted by the accepting unit 52, for example, in the storage unit 51 in association with a first speaker identifier, but may accumulate it in an external storage medium, and there is no limitation on where the information is accumulated. The accumulating unit 531 accumulates information such as the second audio accepted by the accepting unit 52, for example, in the storage unit 51 in association with a second speaker identifier, but may accumulate it in an external storage medium, and there is no limitation on where the information is accumulated.

For example, the accumulating unit 531 accumulates the first audio accepted by the first audio accepting unit 521 and the second audio accepted by the second audio accepting unit 522 in association with each other.

For example, for each set of a first speaker identifier and a second speaker identifier constituting one or more pieces of set information stored in the storage unit 1, the accumulating unit 531 may accumulate first audio received by the first audio accepting unit 521 in a pair with the first speaker identifier and second audio received by the second audio accepting unit 22 in a pair with the second speaker identifier in association with each other. The processing by a later-described audio association processing unit 32 may also be performed for each set of a first speaker identifier and a second speaker identifier constituting one or more pieces of stored set information.

The associating may be, for example, associating the whole of the first audio and the whole of the second audio, or associating one or at least two portions of the first audio and one or at least two portions of the second audio. In the case of the latter, for example, the accumulating unit 31 accumulates one or more first audio segments and one or more second audio segments associated by the audio association processing unit 32. The thus accumulated pair of first audio or one or more first audio segments of the first audio and second audio or one or more second audio segments of the second audio can be called, for example, “a corpus of an audio pair”.

The audio association processing unit 532 associates a first audio segment and a second audio segment. The first audio segment is part of the first audio, and the second audio segment is part of the second audio. “Part” is typically a portion corresponding to one sentence, but may also be a portion corresponding to a paragraph, a phrase, a freestanding word, or the like, for example.

The first sentence block is a sentence block corresponding to the whole of first audio, and the second sentence block is a sentence block corresponding to the whole of second audio. The first sentence is each of one or at least two sentences constituting a first sentence block, and the second sentence is each of one or at least two sentences constituting a second sentence block.

For example, the audio association processing unit 532 may perform dividing processing based on a silence period, on each of first audio and second audio. The silence period is a period in which the state with an audio level of not greater than a threshold is maintained for a predetermined length of time or more.

The dividing processing based on a silence period is processing that detects one or more silence periods in one piece of audio and divides the one piece of audio into two or more segments at the one or more silence periods. Each of the two or more segments typically corresponds to one sentence, but may correspond to one paragraph. If the word order is the same in the first sentence and the second sentence, each of them may correspond to one sentence segment, one independent word, or the like.

Then, it is also possible that the audio association processing unit 532 specifies two segments that correspond to each other between first audio and second audio, and associates a first audio segment and a second audio segment, which are audio of the two segments, with each other.

For example, it is also possible that the audio association processing unit 532 respectively associates two or more segments of first audio with the numbers such as “1”, “2”, and “3”, and respectively associates two or more segments of second audio with the numbers such as “1”, “2”, and “3”, and each pair of two segments with which the same number is associated is considered as a first audio segment and a second audio segment that correspond to each other. That is to say, the audio association processing unit 32 may sequentially associate two or more segments of first audio and two or more segments of second audio with each other.

Alternatively, for example, timing information is associated with each segment, and the audio association processing unit 32 acquires timing information associated with an m-^{th} segment (m is an integer of 1 or more: e.g., the first segment) out of two or more segments of first audio and timing information associated with an m-^{th} segments (e.g., the first segment) out of two or more segments of second audio, and acquires a difference between the two pieces of timing information. Alternatively, the audio association processing unit 32 acquires timing information associated with two or more segments (e.g., three segments) from the m-^{th} to n-^{th} segments (n is an integer greater than m: e.g., the third segment) out of two or more segments of first audio and timing information associated with two or more segments (e.g., three segments) from the m-^{th} to n-^{th} segments out of two or more segments of second audio, acquires differences each between the two pieces of timing information that correspond to each other, and acquires an average of the acquired two or more differences (e.g., three differences). Then, the audio association processing unit 32 may regard an acquired difference or an average of acquired difference as a delay of the second audio relative to the first audio, and regard two segments whose difference is the same as or close enough to be considered as the same as the delay, between the two or more segments of the first audio and the two or more segments of the second audio, as segments that correspond to each other.

Alternatively, for example, it is also possible that the audio association processing unit 532 performs, for a first sentence block and a second sentence block corresponding to first audio and second audio, thereby specifying a first sentence and a second sentence that correspond to each other, and associates a first audio segment and a second audio segment corresponding to the first sentence and the second sentence in association with each other.

Specifically, for example, the audio association processing unit 532 performs speech recognition on the first audio and the second audio, thereby acquiring a first sentence block and a second sentence block. Next, the audio association processing unit 32 performs morphological analysis on the acquired first sentence block and second sentence block, thereby specifying two morphemes (which may be, for example, sentences, paragraphs, phrases, independent words, etc.) that correspond to each other between the first audio and the second audio. Then, the audio association processing unit 32 associates a first audio segment and a second audio segment corresponding to the specified two morphemes, with each other.

More specifically, the dividing part 5321 constituting the audio association processing unit 532 divides the first sentence block into two or more sentences, thereby acquiring two or more first sentences, and divides the second sentence block into two or more sentences, thereby acquiring two or more second sentences. The dividing is performed, for example, through morphological analysis, natural language processing, machine learning, or the like, but may be performed based on a silence period of first audio and second audio. The dividing is not limited to dividing of one sentence block into two or more sentences, and may be, for example, dividing of one sentence into two or more words, or the like. The technique for dividing a sentence into words through natural language processing or the like is known, and thus a detailed description thereof has been omitted (e.g., “Natural Language Processing Through Machine Learning”, Yuta Tsuboi, IBM Japan, ProVISION No. 83/Fall 2014).

The sentence associating part 5322 associates one or more first sentences out of the two or more first sentences acquired by the dividing part 5321 with one or more first sentences out of the two or more second sentences acquired by the dividing part 5321. For example, the sentence associating part 5322 sequentially associates one or more first sentences with one or more second sentences. The sentence associating part 5322 may the same type of two morphemes (e.g., a verb of a first sentence and a verb of a second sentence) with each other, in a first sentence and a second sentence that correspond to each other.

The sentence associating part 5322 may associate one first sentence and two or more second sentences acquired by the dividing part 5321, with each other. The two or more second sentences may be an interpreted sentence of the first sentence or a supplemental sentence of the interpreted sentence. The first sentence is, for example, a sentence including a proverb, a four-character phrase, or the like, and the supplemental sentence may be a sentence explaining the meaning of the proverb or the like whereas the interpreted sentence includes the proverb or the like as it is. Alternatively, the first sentence may be, for example, a sentence using a metaphor, the supplemental sentence may be an interpreted sentence that directly translates the sentence using the metaphor, and the supplemental sentence may be a sentence that explains the meaning of the directly translated metaphor.

Specifically, the sentence associating part 5322 may detect a second sentence corresponding to each of one or more first sentences acquired by the dividing part 5321, and associate a second sentence not associated with the first sentence, with a first sentence corresponding to a second sentence located before the second sentence, thereby associating one first sentence with two or more second sentences. The second sentence corresponding to a first sentence is an interpreted sentence of the first sentence, and a second sentence not associated with the first sentence is, for example, a supplemental sentence of the interpreted sentence.

More specifically, it is preferable that, for example, the sentence associating part 5322 detects, for each of one or more acquired first sentences, one or more second sentences not associated with the first sentence, determines whether or not each of the detected one or more second sentences has a predetermined relationship with a second sentence located immediately therebefore, and, in a case of determining that the second sentence has a predetermined relationship therewith, associates the second sentence with a first sentence corresponding to a second sentence located before the second sentence.

The predetermined relationship is, for example, a relationship that the second sentence is a sentence that explains a second sentence located therebefore. For example, if a second sentence is “Me kara uroko means that the image is such clear as the scales fall from one's eyes.” and a second sentence located therebefore is “The clear image of this camera is just me kara uroko.”, it is determined that this relationship is satisfied.

Alternatively, the predetermined relationship may be, for example, a relationship that the second sentence is a sentence that contains an independent word contained in a second sentence located therebefore. For example, if the second sentence and a second sentence located therebefore are the two example sentences mentioned above, it is determined that this relationship is satisfied.

Alternatively, the predetermined relationship may be, for example, a relationship that the second sentence is a sentence whose subject is an independent word contained in a second sentence located therebefore. For example, if the second sentence and a second sentence located therebefore are the two example sentences mentioned above, it is determined that this relationship is satisfied.

Furthermore, the sentence associating part 5322 may detect second sentence associated with each of two or more first sentences acquired by the dividing part 5321, and also detects a first sentence not associated with any second sentence. The first sentence not associated with any second sentence can be said to be a source sentence that lacks an interpreted sentence, and be an untranslated sentence that has not been translated.

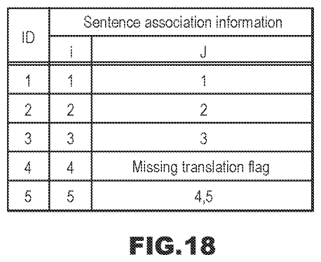

The sentence associating part 5322 may specifically constitute, for example, two or more pieces of sentence association information (see FIG. 18, which will be described later). The sentence association information is information regarding association between two or more first sentences constituting a first sentence and two or more second sentences constituting a second sentence corresponding to the first sentence. The sentence association information will be described in the specific examples.

For example, the machine translation part 53221 machine-translates two or more first sentences acquired by the dividing part 5321 into a second language.

Alternatively, the machine translation part 53221 may machine-translate two or more second sentences acquired by the dividing part 5321.

The translation result associating part 53222 compares a translation result of two or more first sentences machine-translated by the machine translation part 53221 and two or more second sentences acquired by the dividing part 5321, and associates one or more first sentences and one or more second sentences acquired by the dividing part 5321, with each other.

Alternatively, the translation result associating part 53222 compares a translation result of two or more second sentences machine-translated by the machine translation part 53221 and two or more first sentences acquired by the dividing part 5321, and associates one or more first sentences and one or more second sentences acquired by the dividing part 5321, with each other.

The audio associating part 5323 associates a first audio segment corresponding to the one or more first sentences associated by the sentence associating part 5322 with a second audio segment corresponding to the one or more second sentences associated by the sentence associating part 5322.

The timing information acquiring part 5324 acquires two or more pieces of first timing information associated with the two or more first sentences and two or more pieces of second timing information associated with the two or more second sentences. The first timing information is timing information associated with a first sentence, and the second timing information is timing information associated with a first sentence. The timing information will be described later.

The timing information associating part 5325 associates the two or more pieces of first timing information with the two or more first sentences, and associates the two or more pieces of second timing information with the two or more second sentences.

For example, the speech recognition unit 533 performs speech recognition processing on the first audio, thereby acquiring a first sentence block. The first text is text corresponding to the first audio. The speech recognition processing is a known technique, and thus a detailed description thereof has been omitted.

Furthermore, the speech recognition unit 533 performs speech recognition processing on the second audio, thereby acquiring a second sentence block. The second sentence block is text corresponding to the second audio.

For example, the evaluation acquiring unit 534 acquires evaluation information, using an association result of one or more first sentences and one or more second sentences acquired by the sentence associating part 5322. The evaluation information is information regarding evaluation of an interpreter who performed simultaneous interpretation. The evaluation information is, for example, first evaluation information, second evaluation information, third evaluation information, comprehensive evaluation information, or the like, but it may be any types of information as long as it is information regarding evaluation of an interpreter.

The first evaluation information is evaluation information regarding missing translation. The first evaluation information is, for example, information in which the smaller the number of missing translation parts, the higher the evaluation value, and the larger the number of missing translation parts, the lower the evaluation value. The evaluation value is specifically expressed, for example, as five integer values from “1” indicating the lowest evaluation to “5” indicating the highest evaluation, but may also be a numerical value such as “4.5” having a decimal part as well, “A, B, C”, “Excellent, Good, Fair” or the like, and there is no limitation on the form thereof. The same applies to evaluation values in the second evaluation information and the third evaluation information.

The second evaluation information is evaluation information regarding a supplement. The second evaluation information is, for example, information in which the larger the number of supplemental sentences, the higher the evaluation value, and the smaller the number of supplemental sentences, the lower the evaluation value. The number of supplemental sentences can be said to be the number of first sentences each associated with two or more second sentences.

The third evaluation information is evaluation information regarding a delay. The third evaluation information is, for example, information in which the shorter the delay, the higher the evaluation value, and the longer the delay, the lower the evaluation value.

The comprehensive evaluation information is information regarding comprehensive evaluation. The comprehensive evaluation information is acquired, for example, based on two or more types of evaluation information out of the three types of evaluation information consisting of the first to third evaluation information. The comprehensive evaluation information is specifically expressed, for example, as “A”, “A-”, “B”, or the like, but may be a numerical value, and there is no limitation on the form thereof.

The association result is, for example, a group of pairs of a first sentence and a second sentence associated with each other (i.e., a pair of a source sentence and an interpreted sentence thereof, which may be hereinafter referred to as a source-interpretation pair), but also contains one or at least two first sentences not associated with any second sentence and one or at least two second sentences not associated with any first sentence.

For example, the evaluation acquiring unit 534 may detect one or at least two first sentences not associated with any second sentence (i.e., the above-described uninterpreted sentence), and acquire the number of detected uninterpreted sentences. Then, the evaluation acquiring unit 534 acquires first evaluation information in which the larger the number of uninterpreted sentences, the lower the rating.

Specifically, for example, the evaluation acquiring unit 534 may acquire first evaluation information indicating an evaluation value calculated using a decreasing function in which the number of uninterpreted sentences is taken as a parameter. Alternatively, for example, first association information, which is a group of pairs of the number of supplemental sentences and an evaluation value, may be stored in the storage unit 1, and the evaluation acquiring unit 534 may search for first association information using the acquired number of uninterpreted sentences as a key, thereby acquiring first evaluation information indicating an evaluation value that is paired with the number.

Furthermore, for example, the evaluation acquiring unit 534 may detect one or at least two second sentences not associated with any first sentence (i.e., the above-described supplemental sentence), and acquire the number of detected supplemental sentences. Then, the evaluation acquiring unit 534 acquires second evaluation information in which the larger the number of supplemental sentences, the higher the rating.

Specifically, for example, the evaluation acquiring unit 534 may acquire second evaluation information indicating an evaluation value calculated using an increasing function in which the number of supplemental sentences is taken as a parameter. Alternatively, for example, second association information, which is a group of pairs of the number of supplemental sentences and an evaluation value, may be stored in the storage unit 51, and the evaluation acquiring unit 534 may search for second association information using the acquired number of supplemental sentences as a key acquiring second evaluation information indicating an evaluation value that is paired with the number.

It is also possible to use the number of source sentences with supplements, instead of the number of supplemental sentences. The source sentences with supplements are each a source sentence having one or more supplemental sentences in addition to an interpreted sentence, and can be said to be, for example, one first sentence associated with two or more second sentences. The evaluation acquiring unit 534 may detect one or at least two source sentences with supplements, and acquire second evaluation information in which the larger the number of detected source sentences with supplements, the higher the rating. The function used in this case is an increasing function in which the number of source sentences with supplements is taken as a parameter, and the second association information is a group of pairs of the number of source sentences with supplements and an evaluation value.

Furthermore, for example, the evaluation acquiring unit 534 may acquire a delay of second audio relative to first audio. The delay may be, for example, a difference between first timing information associated with a first sentence and second timing information associated with a second sentence, the first sentence and the second sentence constituting one source-interpretation pair.

Specifically, for example, the first audio and the second audio are associated with timing information. The timing information is information for specifying a timing. The timing that is specified is, for example, a timing at which utterance of each of two or more audio segments corresponding to two or more sentences constituting one sentence block occurred. The timing at which utterance occurred may be a timing at which utterance of an audio segment was started, a timing at which utterance was ended, or an average timing obtained by averaging the start timing and the end timing. The first audio and second audio may be associated in advance with such timing information. The timing information is, for example, information (e.g., “0:05”, etc.) indicating the time taken until utterance of the audio segment in the first audio occurred after a predetermined point in time (e.g., a point in time at which utterance of the first audio is started), but may also be information indicating the current time at which utterance of the audio segment occurred, or the like, and there is no limitation on the form thereof.

Alternatively, the timing information acquiring part 5324 may acquire two or more pieces of first timing information associated with the two or more first sentences, and two or more pieces of second timing information associated with the two or more second sentences, and the timing information associating part 5325 may associate the acquired two or more pieces of first timing information with two or more first sentences and the acquired two or more pieces of second timing information with two or more second sentences.

Specifically, for example, during period in which the first audio accepting unit 521 is accepting first audio, the first audio accepting unit performs processing that acquires time information indicating the time, the number, or the like at predetermined time intervals (e.g., 1 sec, 1/30 sec, etc.), and delivers the accepted first audio in association with the acquired time information to the accumulating unit 531. Also, during period in which the second audio accepting unit 522 is accepting second audio, the second audio accepting unit performs processing that acquires time information at predetermined time intervals, and delivers the accepted second audio in association with the acquired time information to the accumulating unit 531. Furthermore, the accumulating unit 531 performs processing that accumulates the first audio associated with the two or more pieces of time information and the second audio associated with the two or more pieces of time information, in the storage unit 51, in association with each other.

At a point in time at which the dividing part 5321 acquires two or more first sentences, the timing information acquiring part 5324 acquires two or more pieces of time information associated with two or more first audio segments corresponding to the two or more first sentences, from the storage unit 51, and, at a point in time at which the dividing part 5321 acquires two or more second sentences, the dividing part acquires two or more pieces of time information associated with two or more second audio segments corresponding to the two or more second sentences, from the storage unit 51.

the timing information associating part 5325 associates two or more pieces of first timing information corresponding to two or more pieces of time information acquired in response to acquisition of the two or more first sentences, with the two or more first sentences, and associates two or more pieces of second timing information corresponding to two or more pieces of time information acquired in response to acquisition of the two or more second sentences, with the two or more second sentences.

For example, the evaluation acquiring unit 534 may acquire a difference (i.e., the above-described delay) between the first timing information associated with the first sentence associated by the sentence associating part 5322 and the second timing information associated with the second sentence associated with the first sentence. Then, the evaluation acquiring unit 534 acquires third evaluation information in which the larger the acquired difference, the lower the evaluation value.

Specifically, for example, the evaluation acquiring unit 534 may acquire third evaluation information indicating an evaluation value calculated using an increasing function in which the delay is taken as a parameter. Alternatively, for example, third association information, which is a group of pairs of a delay value and an evaluation value, may be stored in the storage unit 51, and the evaluation acquiring unit 534 may search for third association information using the acquired delay value as a key, thereby acquiring third evaluation information indicating an evaluation value that is paired with the delay value.

For example, the evaluation acquiring unit 534 acquires comprehensive evaluation information based on two or more types of evaluation information out of the three types of evaluation information consisting of the first to third evaluation information. The comprehensive evaluation information may be, for example, a representative value (e.g., an average, a median, a mode, etc.) of the two or more types of evaluation information, or evaluation information such as “A” or “B” associated with the representative value. The various types of evaluation information will be described in the specific examples.

The thus acquired various types of evaluation information may be, for example, accumulated in the storage unit 51 in association with an interpreter identifier. The interpreter identifier is information for identifying an interpreter. The interpreter identifier is, for example, an e-mail address, a telephone number, a name, an ID, or the like, and any type of identifier is possible.

The output unit 54 outputs various types of information. The various types of information are, for example, an untranslated sentence, evaluation information, or the like. The output unit 54 outputs various types of information, for example, through transmission to a terminal display on a display screen, or the like, but the outputting may be printing by a printer, accumulation in a storage medium, delivery to another program, or the like, and there is no limitation on the output mode.

The missing interpretation output unit 541 outputs a detection result of the sentence associating part 5322. The detection result is, for example, detected one or more uninterpreted sentences, but may be the number of detected uninterpreted sentences or the like. The uninterpreted sentences that are output are each, for example, a translated sentence obtained through machine translation of an uninterpreted first sentence in a first language into a second language, but may be an uninterpreted first sentence itself. Alternatively, the missing interpretation output unit 541 may output an uninterpreted first sentence and a translated sentence obtained through machine translation thereof.

The evaluation output unit 542 outputs the evaluation information acquired by the evaluation acquiring unit 534. For example, if the accepting unit 52 receives an instruction to output evaluation information in a pair with a terminal identifier, the evaluation output unit 542 transmits evaluation information acquired by the evaluation acquiring unit 534, to a terminal that is identified with the terminal identifier.

Alternatively, for example, if the accepting unit 52 accepts an instruction to output evaluation information via an input device such as a touch panel, the evaluation output unit 542 may output evaluation information acquired by the evaluation acquiring unit 534, via an output device such as a display screen.

The storage unit 51 is, for example, preferably a non-volatile storage medium such as a hard disk or a flash memory, but can also be realized by a volatile storage medium such as a RAM.

There is no limitation on the procedure in which information is stored in the storage unit 51. For example, information may be stored in the storage unit 1 via a storage medium, information transmitted via a network, a communication line, or the like may be stored in the storage unit 1, or information input via an input device may be stored in the storage unit 51. There is no limitation on the input device, and examples thereof include a keyboard, a mouse, a touch panel, and a microphone.

The accepting unit 52, the first audio accepting unit 521, and the second audio accepting unit 522 may be considered to include or to not include an input device. The accepting unit 52 and the like may be realized by driver software for an input device, a combination of an input device and driver software therefor, or the like.

The processing unit 53, the accumulating unit 531, the audio association processing unit 532, the speech recognition unit 533, the evaluation acquiring unit 534, the dividing part 5321, the sentence associating part 5322, the audio associating part 5323, the timing information acquiring part 5324, the timing information associating part 5325, the machine translation part 53221, and the translation result associating part 53222 may be realized typically by MPUs, memories, or the like. Typically, the processing procedure of the processing unit 53 and the like is realized by software, and the software is stored in a storage medium such as a ROM. Note that the processing procedure may be realized also by hardware (dedicated circuits).

The output unit 54, the missing interpretation output unit 541, and the evaluation output unit 542 may be considered to include or to not include an output device such as a display screen or a speaker device. The output unit 54 and the like may be realized by driver software for an output device, a combination of an output device and driver software therefor, or the like.

The receiving function of the accepting unit 52 is typically realized by a wired or wireless communication part (e.g., a communication module such as a NIC (network interface controller) or a modem), but may also be realized by a broadcast receiving part (e.g., a broadcast receiving module).

The transmitting function of the output unit 54 is typically realized by a wired or wireless communication part, but may also be realized by a broadcasting part (e.g., a broadcasting module).

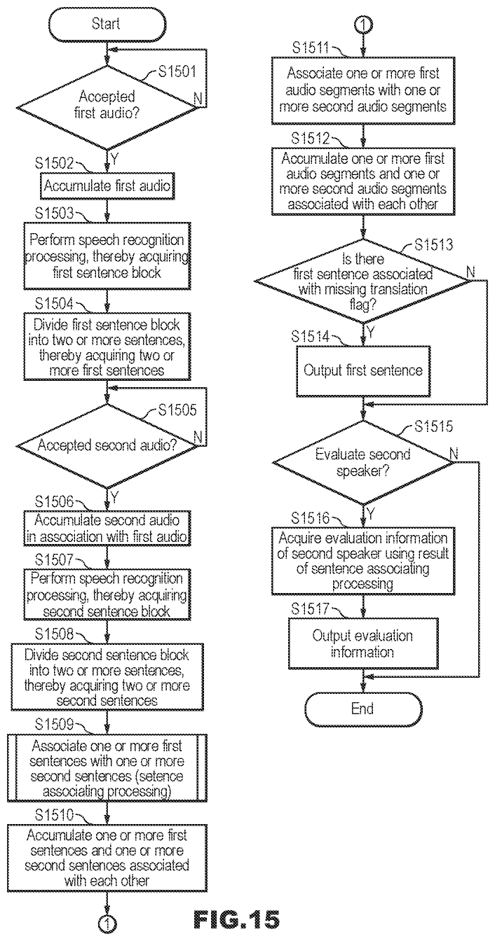

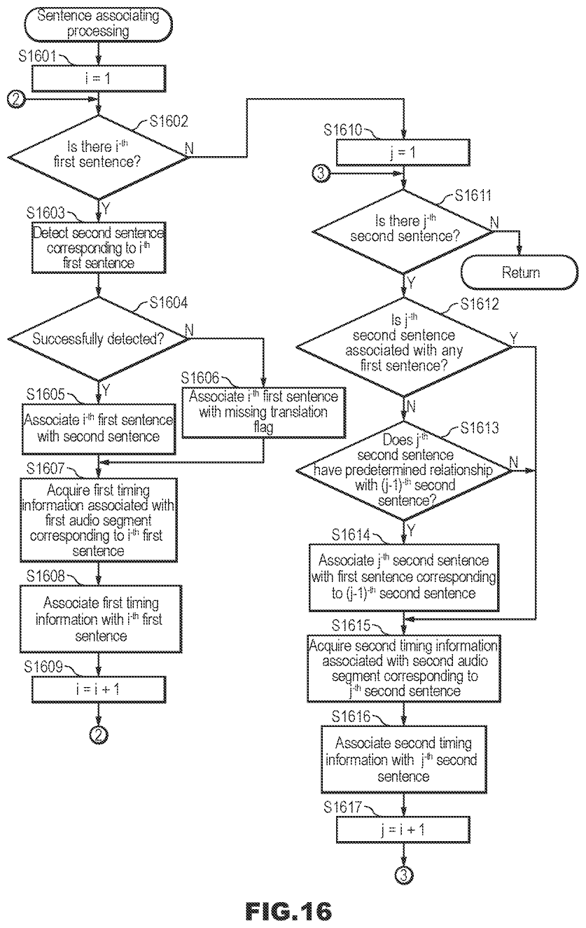

Next, an operation of the audio processing apparatus will be described with reference to the flowcharts in FIGS. 15 and 16. FIG. 15 is a flowchart illustrating an operation of the audio processing apparatus.

(Step S1501) The processing unit 53 determines whether or not the first audio accepting unit 521 has accepted first audio. If it is determined that the first audio accepting unit 521 has accepted, the procedure advances to step S1502, or otherwise the procedure returns to step S1501.

(Step S1502) The accumulating unit 531 accumulates the first audio accepted in step S201, in the storage unit 1.

(Step S1503) The speech recognition unit 533 performs speech recognition processing on the first audio accepted in step S1501, thereby acquiring a first sentence block.

(Step S1504) The dividing part 5321 divides the first sentence block acquired in step S1503 into two or more sentences, thereby acquiring two or more first sentences.

(Step S1505) The processing unit 53 determines whether or not the second audio accepting unit 22 has accepted second audio. If it is determined that the second audio accepting unit 522 has accepted second audio, the procedure advances to step S1506, or otherwise the procedure returns to step S1505.

(Step S1506) The accumulating unit 531 accumulates the second audio accepted in step S1505, in the storage unit 1, in association with the first audio.

(Step S1507) The speech recognition unit 533 performs speech recognition processing on the second audio accepted in step S1505, thereby acquiring a second sentence block.

(Step S1508) The dividing part 5321 divides the second sentence block acquired in step S1507 into two or more sentences, thereby acquiring two or more second sentences.

(Step S1509) The sentence associating part 5322 performs sentence associating processing, which is processing that associates one or more first sentences out of the two or more first sentences acquired in step S1504 with one or more second sentences out of the two or more second sentences acquired in step S1508. The sentence associating processing will be described with reference to FIG. 16.

(Step S1510) The accumulating unit 531 accumulates the one or more first sentences and the one or more second sentences associated in step S1509, in the storage unit 1.

(Step S1511) The audio associating part 5323 associates one or more first audio segments corresponding to the one or more first sentences with one or more second audio segments corresponding to the one or more second sentences.

(Step S1512) The accumulating unit 531 accumulates the one or more first audio segments and the one or more second audio segments associated in step S1511, in the storage unit 1.

(Step S1513) The processing unit 53 determines whether or not there is a first sentence associated with a missing translation flag, using a result of the sentence associating processing in step S1509. If it is determined that there is a first sentence associated with a missing translation flag, the procedure advances to step S1514, or otherwise the procedure advances to step S1515.

(Step S1514) The missing interpretation output unit 541 outputs the first sentence. The output in this flowchart is, for example, display on a display screen, but may also be transmission to a terminal.

(Step S1515) The processing unit 53 determines whether or not to evaluate a second speaker. For example, if the accepting unit 52 accepts an instruction to output evaluation information, the processing unit 53 determines to evaluate a second speaker. Alternatively, in response to the completion of the sentence associating processing in step S1509, the processing unit 53 may determine to evaluate a second speaker. If it is determined that a second speaker is to be evaluated, the procedure advances to step S1516, or otherwise the processing is ended.

(Step S1516) The evaluation acquiring unit 534 acquires evaluation information of a second speaker who uttered second audio of speech, using a result of the sentence associating processing in step S1509.

(Step S1517) The evaluation output unit 542 outputs the evaluation information acquired in step S1516. Subsequently, the processing is ended.

FIG. 16 is a flowchart illustrating the sentence associating in processing step S1507.

(Step S1601) The sentence associating part 5322 sets a variable i to an initial value “1”. The variable i is a variable for sequentially selecting unselected first sentences out of the two or more first sentences acquired in step S1504.

(Step S1602) The sentence associating part 5322 determines whether or not there is an i-^{th} first sentence. If it is determined that there is an i-th first sentence, the procedure advances to step S1603, or otherwise the procedure advances to step S1610.

(Step S1603) The sentence associating part 5322 detects a second sentence corresponding to the i-^{th} first sentence.

Specifically, the machine translation part 53221 machine-translates the i-^{th} first sentence into the second language, and the translation result associating part 53222 compares a translation result of the i-^{th} first sentence and each of the two or more second sentences acquired in step S1508, thereby acquiring a similarity degree. Then, the translation result associating part 53222 specifies a second sentence with a highest similarity degree with the translation result, and detects the specified second sentence if the similarity degree of the specified second sentence is higher than or equal to a threshold. If the similarity degree of the specified second sentence is lower than the threshold, a second sentence corresponding to the i-^{th} first sentence is not detected.

(Step S1604) The sentence associating part 5322 determines whether or not the detection in step S1603 was successful. If it is determined that the detection was successful, the procedure advances to step S1605, or otherwise the procedure advances to step S1606.

(Step S1605) The sentence associating part 5322 associates the i-th first sentence with the second sentence detected in step S1603. Subsequently, the procedure advances to step S1607.

(Step S1606) The sentence associating part 5322 associates the i-th first sentence with a missing translation flag.

(Step S1607) The timing information acquiring part 5324 acquires first timing information associated with the first audio segment corresponding to the i-^{th} first sentence.

(Step S1608) The timing information associating part 5325 associates the first timing information with the i-^{th} first sentence.

(Step S1609) The sentence associating part 5322 increments the variable i. Subsequently, the procedure returns to step S1602.

(Step S1610) The sentence associating part 5322 sets a variable j to an initial value “1”. The variable j is a variable for sequentially selecting unselected second sentences out of the two or more second sentences acquired in step S1508.

(Step S1611) The sentence associating part 5322 determines whether or not there is a j-^{th} second sentence. If it is determined that there is a j-th second sentence, the procedure advances to step S1612, or otherwise the procedure returns to the upper-level processing.

(Step S1612) The sentence associating part 5322 determines whether or not the j-^{th} second sentence is associated with any first sentence. If the j-th second sentence is associated with a first sentence, the procedure advances to step S1613, or otherwise the procedure advances to step S1615.

(Step S1613) The sentence associating part 5322 determines whether or not the j-^{th} second sentence has a predetermined relationship with a (j−1)-th second sentence. If it is determined that the j-^{th} second sentence has a predetermined relationship with a (j−1)-^{th} second sentence, the procedure advances to step S1614, or otherwise the procedure advances to step S1615.

(Step S1614) The sentence associating part 5322 associates the j-^{th} second sentence with a first sentence corresponding to the (j−1)-^{th} second sentence.

(Step S1615) The timing information acquiring part 5324 acquires second timing information associated with the second audio segment corresponding to the j-^{th} second sentence.

(Step S1616) The timing information associating part 5325 associates the second timing information with the j-^{th} second sentence.

(Step S1617) The sentence associating part 5322 increments the variable j. Subsequently, the procedure returns to step S1611.

Hereinafter, specific operation examples of the audio processing apparatus in this embodiment will be described. The following description is not intended to limit the scope of the present invention in any way, and various changes are possible.

A conventional audio processing apparatus is, for example, a stand-alone terminal installed at a lecture place. The terminal is connected to a first microphone for a first speaker installed on a podium at the place, a second microphone for a second speaker installed in an interpreter's booth at the place, and an external display screen for an audience. The first speaker is a lecturer and utters first audio of speech in Japanese, which is a first language. The second speaker performs simultaneous interpretation of the first audio of speech uttered by the first speaker while listening to the audio, into English, which is a second language, and utters second audio of speech in English.

In the audio processing apparatus, the first audio accepting unit 521 accepts first audio “Kyo ha wagasha no futatsu no shinseihin wo gosbokai shimasu. Hitotsume ha sumatofuon desu. Kono sumatofuon ha shinkaihatsu no kamera wo tosai shiteimasu. Kono kamera ha A-sha sei desu. Kono kamera no semmei na gazo ha masani me kara uroko desu.” via the first microphone, and the accumulating unit 531 accumulates the accepted first audio in the storage unit 51. The first audio that is accumulated is associated with first time information (“0:01”, “0:02”, etc.) at every second.

The speech recognition unit 533 performs speech recognition processing on the accepted first audio, thereby acquiring a first sentence block “Kyo ha wagasha no futatsu no shinseihin wo goshokai shimasu. Hitotsume ha sumatofuon desu. Kono sumatofuon ha shinkaihatsu no kamera wo tosai shiteimasu. Kono kamera ha A-sha sei desu. Kono kamera no semmei na gazo ha masani me kara uroko desu.”

The dividing part 5321 divides the acquired first sentence block into five portions, thereby acquiring five first sentences “Kyo ha wagasha no futatsu no shinseihin wo goshokai shimasu.”, “Hitotsume ha sumatofuon desu.”, “Kono sumatofuon ha shinkaihatsu no kamera wo tosai shiteimasu.”, “Kono kamera ha A-sha sei desu.”, and “Kono kamera no semmei na gazo ha masani me kara uroko desu.”

The second audio accepting unit 522 accepts second audio “Today we introduce two new products of our company. The first is a smartphone. This smartphone is equipped with a newly developed camera. The clear image of this camera is just me kara uroko. Me kara uroko means that the image is such clear as the scales fall from one's eyes.” via the second microphone, and the accumulating unit 531 accumulates the accepted second audio in the storage unit 51 in association with the first audio. The second audio that is accumulated is associated with second time information (“0:05”, “0:06”, etc.) at every second.

The speech recognition unit 533 performs speech recognition processing on the accepted second audio, thereby acquiring a second sentence block “Today we introduce two new products of our company. The first is a smartphone. This smartphone is equipped with a newly developed camera. The clear image of this camera is just me kara uroko. Me kara uroko means that the image is such clear as the scales fall from one's eyes.”

The dividing part 5321 divides the acquired second sentence block into five portions, thereby acquiring five second sentences “Today we introduce two new products of our company.”, “The first is a smartphone.”, “This smartphone is equipped with a newly developed camera.”, “The clear image of this camera is just me kara uroko.”, and “Me kara uroko means that the image is such clear as the scales fall from one's eyes.”

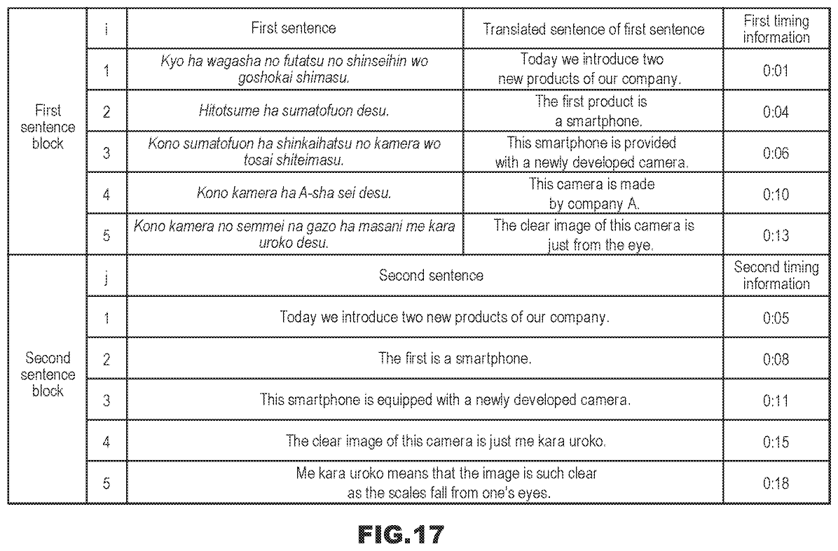

The accumulating unit 531 accumulates the acquired first sentence block and the acquired second sentence block, for example, the storage unit 51 in association with each other as shown in FIG. 17. FIG. 17 is a structure diagram of a first sentence block and a second sentence block stored in association with each other. The first sentence block is constituted by two or more first sentences (five first sentences, in this example). The second sentence block is constituted by two or more second sentences (five second sentences, in this example).

Each of two or more first sentences constituting the first sentence block is associated with the variable i described in the flowchart. Each of two or more first sentences is also associated with the first time information. Furthermore, each of two or more first sentences may also be associated with a translated sentence of the first sentence.

In a similar manner, each of two or more second sentences constituting the second sentence block is associated with the variable j. Each of two or more second sentences is also associated with the second time information.

The sentence associating part 5322 performs the following sentence associating processing that associates one or more first sentences out of the acquired two or more first sentences (five first sentences in this example) with one or more second sentences out of the acquired two or more second sentences (five second sentences in this example).

That is to say, the sentence associating part 5322 first detects a second sentence corresponding to a P first sentence. Specifically, the machine translation part 53221 machine-translates the 1-^{st} first sentence “Kyo ha wagasha no futatsu no shinseihin wo gosbokai shimasu.”, thereby acquiring a translation result “Today we introduce two new products of our company.” The translation result may be accumulated, for example, in association with the 1st first sentence as shown in FIG. 17.

The translation result associating part 53222 compares the translation result and each of the acquired two or more second sentences, thereby detecting a 1-^{st} second sentence “Today we introduce two new products of our company.” that is a second sentence matching the translation result. The sentence associating part 5322 associates the 1-^{st} first sentence “Kyo ha wagasha no futatsu no shinseihin wo goshokai shimasu.” with the detected 1-^{st} second sentence “Today we introduce two new products of our company.”.

Furthermore, the timing information acquiring part 5324 acquires first timing information associated with the first audio segment corresponding to the 1st first sentence. In this example, it is assumed that the first timing information “0:01” is acquired. The timing information associating part 5325 associates the 1st first sentence with the first timing information “0:01”.

Next, a translation result “The first product is a smartphone.” of the 2-^{nd} first sentence “Hitotsume ha sumatofuon desu.” is acquired, and a 2-^{nd} second sentence “The first is a smartphone.” that is a second sentence similar to the translation result is detected, and thus the 2-^{nd} first sentence “Hitotsume ha sumatofuon desu.” is associated with the 2-^{nd} second sentence “The first is a smartphone.” The first timing information (“0:04”, in this example) associated with the first audio segment corresponding to the 2-^{nd} first sentence is acquired, and the 2-^{nd} first sentence is associated with the first timing information “0:04”.

Next, a translation result “This smartphone is provided with a newly developed camera.” of the 3-^{rd} first sentence “Kono sumatofuon ha shinkaihatsu no kamera wo tosai shiteimasu.” is acquired, and a second sentence “This smartphone is equipped with a newly developed camera.” that is similar to the translation result is detected, and thus the 3-^{rd} first sentence “Hitotsume ha sumatofuon desu.” is associated with the 3-^{rd} second sentence “The first is a smartphone.” The first timing information (“0:06”, in this example) associated with the first audio segment corresponding to the 3-^{rd} first sentence is acquired, and the 3-^{rd} first sentence is associated with the first timing information “0:06”.

Next, a translation result “This camera is made by company A.” of the 4-^{th} first sentence “Kono kamera ha A-sha sei desu.” is acquired, but a second sentence that matches or similar to the translation result is not acquired, and thus the 4-^{th} first sentence “Kono kameza ha A-sha sei desu.” is associated with a missing translation flag. The first timing information (“0:10”, in this example) associated with the first audio segment corresponding to the 4-th first sentence is acquired, and the 4-^{th} first sentence is associated with the first timing information “0:10”.

Next, a translation result “The clear image of this camera is just from the eye.” of the 5-^{th} first sentence “Kono kamera no semmei na gazo ha masanime kara uroko desu.” is acquired, and a 4-^{th} second sentence “The clear image of this camera is just me kara uroko.” that is a second sentence similar to the translation result is detected, and thus the 5-^{th} first sentence “Kono kamera no semmei na gazo ha masani me kara uroko desu.” is associated with the 4-^{th} second sentence “The clear image of this camera is just me kara uroko.” The first timing information (“0:13”, in this example) associated with the first audio segment corresponding to the 5-^{th} first sentence is acquired, and the 5-^{th} first sentence is associated with the first timing information “0:13”.

Next, the sentence associating part 5322 determines whether or not each of the acquired five second sentences is associated with any first sentence. The 1-^{st} second sentence is associated with the 1-^{st} second sentence, and thus the determination result is positive. The 2-^{nd}, 3-^{rd}, and 4-^{th} second sentences are respective associated with the 2-^{nd}, 3-^{rd}, and 5-^{th} first sentences, and thus the determination results are positive.

The 5-^{th} second sentence is not associated with any second sentence, and thus the determination result is negative. In response to this determination result, the sentence associating part 5322 determines whether or not the 5-^{th} second sentence has a predetermined relationship with a 4-^{th} second sentence, which is a second sentence located immediately therebefore. In this example, the predetermined relationship is, for example, “the second sentence is a sentence containing an independent word contained in a second sentence located immediately therebefore”.

The 5-^{th} second sentence “Me kara uroko means that the image is such clear as the scales fall from one's eyes.” and the 4-^{th} second sentence “The clear image of this camera is just me kara uroko.” contain the same independent word “me kara urokd”, and thus it is determined that the predetermined relationship is satisfied.

In response to this determination result, the sentence associating part 5322 associates the 5-^{th} second sentence “Me kara uroko means that the image is such clear as the scales fall from one's eyes.” with a 5-^{th} first sentence, which is a first sentence corresponding to the 4-^{th} second sentence. Accordingly, the 5-^{th} first sentence is associated with two second sentences consisting of the 4-^{th} and 5-^{th} second sentences.

Next, for each of the acquired five second sentences, the timing information acquiring part 5324 acquires second timing information associated with the second audio segment corresponding to the second sentence, and the timing information associating part 5325 associates the second sentence with the second timing information. In this example, second timing information “0:05” associated with the second audio segment corresponding to the 1-^{st} second sentence is acquired, and the 1-^{st} second sentence is associated with the second timing information “0:05”.

In a similar manner, second timing information “0:08” associated with the second audio segment corresponding to the 2-^{nd} second sentence is acquired, and the 2-^{nd} second sentence is associated with the second timing information “0:08”. Furthermore, second timing information “0:11” associated with the second audio segment corresponding to the 3-^{rd} second sentence is acquired, and the 3-^{rd} second sentence is associated with the second timing information “0:11”. Furthermore, second timing information “0:15” associated with the second audio segment corresponding to the 4-th second sentence is acquired, and the 4-^{th} second sentence is associated with the second timing information “0:15”. Furthermore, second timing information “0:18” associated with the second audio segment corresponding to the 5-^{th} second sentence is acquired, and the 5-^{th} second sentence is associated with the second timing information “0:18”.

In this manner, regarding the five first sentences and the five second sentences described above, the 1-^{st} first sentence is associated with the 1-^{st} second sentence, the 2-^{nd} first sentence is associated with the 2-^{nd} second sentence, the 4-^{th} first sentence is associated with the 3-^{rd} second sentence, the 5-^{th} first sentence is associated with two second sentences consisting of the 4-^{th} and 5-^{th} second sentences, and the 3-^{rd} first sentence is associated with a missing translation flag.

This sort of associating may be, for example, configuring two or more pieces of association information as shown in FIG. 18 and accumulating them in the storage unit 51. FIG. 18 is a structure diagram of sentence association information. The sentence association information has a set (i, j) of a variable i and a variable j. Each of the two or more pieces of sentence association information is associated with an ID (e.g., “1”, “2”, etc.). The sentence association information (hereinafter, sentence association information 1) associated with the ID “1” has (1, 1).

In a similar manner, sentence association information 2 associated with the ID “2” has (2, 2), and sentence association information 3 has (3, 3). Furthermore, sentence association information 4 has (4, missing interpretation flag). Furthermore, sentence association information 5 has (5, 4, 5).

The accumulating unit 531 accumulates the five first sentences and the five second sentences described above associated through this sort of sentence associating processing, in the storage unit 51. The accumulating the five first sentences and the five second sentences associated with each other may be, for example, accumulating two or more pieces of sentence association information as shown in FIG. 18.

Next, the audio associating part 5323 associates five first audio segments corresponding to the five first sentences with five second audio segments corresponding to the five second sentences, and the accumulating unit 531 accumulates the five first audio segments and the five second audio segments associated with each, in the storage unit 51.

Next, the processing unit 53 determines whether or not there is a first sentence associated with a missing translation flag, and, if the determination result is positive, the missing interpretation output unit 541 outputs the first sentence via an external display screen. In this example, the 3-^{rd} first sentence is associated with a missing translation flag, and thus the external display screen the 3-^{rd} first sentence “Kono kamera ha A-sha sei desu” and its translated sentence “This camera is made by company A.” It is also possible that only a translated sentence of the 3-^{rd} first sentence is displayed, and the 3-^{rd} first sentence itself is not displayed. Accordingly, the audience can see the 3-^{rd} translated sentence “This camera is made by company A.”, which a first sentence that was not interpreted simultaneously.

The above-described operation is an operation related to the first audio “Kyo ha wagasha no futatsu no shinseihin wo goshokai shimasu . . . . Kono kamera no semmei na gazo ha masani me kara uroko desu.” and first second audio “Today we introduce two new products of our company . . . . Me kara uroko means that the image is such clear as the scales fall from one's eyes.” The same operation is performed also on the subsequent other pieces of first audio and other pieces of second audio.

It is assumed that, after the lecture is ended, a person in charge of simultaneous interpretation service company to which the second speaker belongs enters an instruction to output evaluation information, via an input device such as a keyboard, to the audio processing apparatus.

In the audio processing apparatus, the accepting unit 52 accepts an instruction to output evaluation information, and the evaluation acquiring unit 534 acquires the number m of uninterpreted sentences, the number n of first sentences each associated with two or more second sentences, and the delay t of the second audio relative to the first audio, with reference to a result of sentence associating processing as shown in FIG. 18. In this example, it is assumed that m=2, n=5, and t=4 sec are acquired.

The delay t is acquired, for example, as follows. That is to say, the evaluation acquiring unit 534 acquires a difference “4 sec” between the first timing information “0:01” associated with the 1-^{st} first sentence and the second timing information “0:05” associated with the 1-^{st} second sentence corresponding thereto. The evaluation acquiring unit 534 acquires a difference “4 sec” between the first timing information “0:04” associated with the 2-^{nd} first sentence and the second timing information “0:08” associated with the 2-^{nd} second sentence corresponding thereto. The evaluation acquiring unit 534 acquires a difference “5 sec” between the first timing information “0:06” associated with the 3-^{rd} first sentence and the second timing information “0:11” associated with the 3-^{rd} second sentence corresponding thereto. Since the 4-^{th} first sentence is associated with a missing interpretation flag, and thus a difference is not acquired.

Furthermore, the evaluation acquiring unit 534 acquires a difference “2 sec” between the first timing information “0:14” associated with the 5-th first sentence, and the former of the two pieces of second timing information “0:15” and “0:18” associated with the two second sentences consisting of the 4-^{th} and 5-^{th} second sentences corresponding thereto. Then, the evaluation acquiring unit 534 acquires a representative value (mode, in this example) “4 sec” of the acquired four differences “4 sec”, “4 sec”, “5 sec”, and “2 sec”.

Next, the evaluation acquiring unit 534 acquires first evaluation information indicating a first evaluation value calculated by substituting the acquired m=2 for a decreasing function in which the number m of uninterpreted sentences is taken as a parameter. The first evaluation value is an evaluation value indicating how small the number of missing translation parts is. The first evaluation value is expressed, for example, as an integer value ranging from “1” indicating the lowest rating to “5” indicating the highest rating. In this example, it is assumed that the first evaluation information “first evaluation value=5” is acquired.

Furthermore, the evaluation acquiring unit 534 acquires second evaluation information indicating a second evaluation value calculated by substituting the acquired n=5 for an increasing function in which the number n of first sentences each associated with two or more second sentences is taken as a parameter. The second evaluation value is an evaluation value indicating how large the number of supplements is. The second evaluation value is also expressed as an integer value ranging from “1” indicating the lowest rating to “5” indicating the highest rating. In this example, it is assumed that the second evaluation information “second evaluation value=4” is acquired.

Furthermore, the evaluation acquiring unit 534 acquires third evaluation information indicating a third evaluation value calculated by substituting the acquired t=4 for an increasing function in which the delay t is taken as a parameter. The third evaluation value is an evaluation value indicating how shorter the delay is. The third evaluation value is, for example, is expressed as an integer value ranging from “1” indicating the lowest rating to “5” indicating the highest rating. In this example, it is assumed that the first evaluation information “first evaluation value=5” is acquired.

Then, the evaluation acquiring unit 534 acquires comprehensive evaluation information indicating comprehensive evaluation, based on three evaluation values consisting of the first to third evaluation values.

Specifically, for example, a group of pairs of an average of three evaluation values consisting of the first to third evaluation values and comprehensive evaluation is stored in the storage unit 51. The pairs of an average and comprehensive evaluation are, for example, a pair of the average “4.5 or more” and the evaluation “A”, a pair of the average “4 or more and less than 4.5” and the evaluation “A-”, a pair of the average “3.5 or more and less than 4” and the evaluation “B”, and the like. The evaluation acquiring unit 534 acquires an average “4.7” of the acquired three evaluation values consisting of the first to third evaluation values “4”, “5”, and “5”, and acquires comprehensive evaluation information “A” corresponding to the average “4.7”.

The evaluation output unit 42 configures evaluation information for output “how small the number of missing translation parts is: 4, how large the number of supplements is: 5, how short the delay is: 5, comprehensive evaluation: A”, based on the acquired first evaluation information “first evaluation value=4, the acquired second evaluation information” second evaluation value=5”, the acquired third evaluation information” third evaluation value=5”, and the acquired comprehensive evaluation information “A”, and outputs the information via a display screen.

Accordingly, the display screen of the audio processing apparatus displays the second speaker evaluation information “how small the number of missing translation parts is: 4, how large the number of supplements is: 5 how short the delay is: 5, comprehensive evaluation: A”, and the person in charge can see the rating of the second speaker.

As described above, according to this embodiment, the audio processing apparatus accepts first audio of speech uttered by a first speaker of a first language, accepts second audio, which is audio obtained through simultaneous interpretation of the first audio into a second language by a second speaker, and accumulates the first audio and the second audio in association with each other, and thus it is possible to accumulate first audio and second audio, which is audio obtained through simultaneous interpretation of the first audio, in association with each other.

Furthermore, the audio processing apparatus is an audio processing apparatus associates a first audio segment, which is part of the first audio, with a second audio segment, which is part of the second audio, and accumulates the first audio segment and the second audio segment associated with each other.

With this configuration, it is possible to accumulate a portion of first audio and a portion of second audio in association with each other.

Furthermore, the audio processing apparatus performs speech recognition processing on the first audio, acquires a first sentence block, which is text corresponding to the first audio, performs speech recognition processing on the second audio, acquires a second sentence block, which is text corresponding to the second audio, divides the first sentence block into two or more sentences, thereby acquiring two or more first sentences, and divides the second sentence block into two or more sentences, thereby acquiring two or more second sentences, associates acquired one or more first sentences and one or more second sentences, associates one or more first audio segments corresponding to the associated one or more first sentences with one or more second audio segments corresponding to the associated one or more second sentences, and accumulates the one or more first audio segments and the one or more second audio segments associated with each other, and thus it is possible to accumulate a first sentence block obtained through speech recognition of first audio and a second sentence block obtained through speech recognition of second audio, in association with each other.

Furthermore, the audio processing apparatus machine-translates the acquired two or more first sentences into the second language or machine-translates the acquired two or more second sentences, compares a translation result of two or more first sentences obtained through machine translation and the acquired two or more second sentences, and associates the acquired one or more first sentences and one or more second sentences, or compares a translation result of two or more second sentences obtained through machine translation and the acquired two or more first sentences, and associates the acquired one or more first sentences and one or more second sentences, and thus it is possible to accumulate a first sentence and a machine translation result of the first sentence in association with each other.

Furthermore, the audio processing apparatus associates acquired one first sentence with two or more second sentences, and thus it is possible to accumulate one first sentence and two or more second sentences in association with each other.

Furthermore, the audio processing apparatus detects a second sentence corresponding to each of one or more acquired first sentences, and associates a second sentence not associated with the first sentence, with a first sentence corresponding to a second sentence located before the second sentence, thereby associating one first sentence with two or more second sentences, and thus it is possible to properly associate one first sentence with two or more second sentences, by associating a second sentence not associated with the first sentence, with a first sentence corresponding to a second sentence located therebefore.

Furthermore, the audio processing apparatus determines whether or not a second sentence is not associated with the first sentence and has a predetermined relationship with a second sentence located immediately therebefore, and, in a case of determining that the second sentence has a predetermined relationship therewith, associates the second sentence not associated with the first sentence, with a first sentence corresponding to the second sentence located before the second sentence, and thus, even when a second sentence is not associated with the first sentence, the second sentence is not associated with a first sentence corresponding to a second sentence located immediately therebefore if it does not have the relationship with that second sentence located immediately therebefore, and thus it is possible to more properly associate one first sentence with two or more second sentences.

Furthermore, the audio processing apparatus detects a second sentence associated with each of two or more acquired first sentences, detects a first sentence not associated with any second sentence, and outputs a detection result, and thus it is possible to detect a first sentence not associated with any second sentence, and to see that there is missing interpretation based on output of a detection result.

Furthermore, the audio processing apparatus acquires evaluation information regarding evaluation of an interpreter who performed simultaneous interpretation, using an association result of one or more first sentences and one or more second sentences, and outputs the evaluation information, and thus it is possible to evaluate an interpreter based on association between a first sentence and a second sentence.

Furthermore, the audio processing apparatus acquires evaluation information in which the larger the number of first sentences each associated with two or more second sentences, the higher the rating, and thus it is possible to perform proper evaluation, by giving a higher rating to an interpreter whose interpretation has a larger number of supplements.

Furthermore, the audio processing apparatus acquires evaluation information in which the smaller the number of first sentences not associated with any second sentence, the lower the rating, and thus it is possible to perform proper evaluation, by giving a lower rating to an interpreter whose interpretation has a larger number of missing parts.

Furthermore, in the above-described configuration, the first audio and second audio are each associated with timing information for specifying timing, and the audio processing apparatus acquires evaluation information in which the larger the difference between the first timing information associated with an associated first sentence and the second timing information associated with a second sentence associated with the first sentence, the lower the rating, and thus it is possible to perform proper evaluation, by giving a lower rating to an interpreter whose interpretation has a longer delay.

Furthermore, the audio processing apparatus acquires two or more pieces of first timing information associated with the two or more first sentences and two or more pieces of second timing information associated with the two or more second sentences, associates the two or more pieces of first timing information with the two or more first sentences, and associates the two or more pieces of second timing information with the two or more second sentences, and thus it is possible to accumulate two or more first sentences in association with two or more pieces of first timing information, and two or more second sentences corresponding to the two or more first sentences in association with two or more pieces of second timing information. Accordingly, it is possible to, for example, evaluate an interpreter, using a delay between a first sentence and a second sentence corresponding to each other.

The processing in this embodiment may be realized by software. The software may be distributed by software downloads or the like. Furthermore, the software may be distributed in a form where the software is stored in a storage medium such as a CD-ROM. The same applies to other embodiments in this specification.

The software that realizes the information processing apparatus is, for example, the following sort of program. Specifically, this program is for causing a computer to function as: a first audio accepting unit 521 that accepts first audio of speech uttered by a first speaker of a first language; a second audio accepting unit 522 that accepts second audio, which is audio obtained through simultaneous interpretation of the first audio into a second language by a second speaker; and an accumulating unit 531 that accumulates the first audio and the second audio in association with each other.

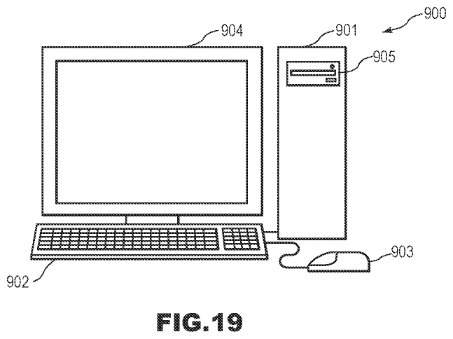

FIG. 19 an external view of a computer system 900 executes the programs according to the foregoing embodiments to realize the server apparatus 1, the audio processing apparatus 5, and the like. The foregoing embodiments may be realized using computer hardware and computer programs executed thereon. In FIG. 19, the computer system 900 includes a computer 901 including a disk drive 905, a keyboard 902, a mouse 903, and a display screen 904. The computer 901 is connected to an unshown first microphone, an unshown second microphone, and an unshown external display screen. The entire system including the keyboard 902, the mouse 903, the display screen 904, and the like may be referred to as a computer.

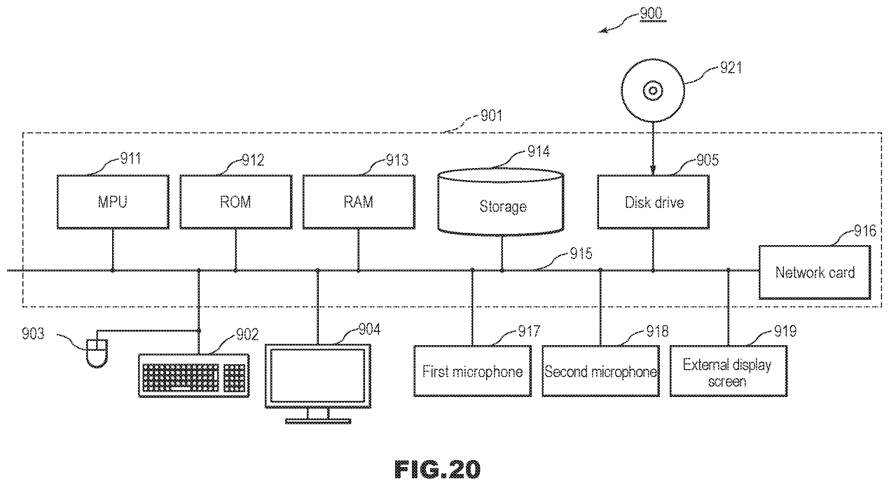

FIG. 20 is a diagram showing an internal configuration of the computer system 900. In FIG. 20, the computer 901 includes, in addition to the disk drive 905, an MPU 911, a ROM 912 in which a program such as a boot up program is to be stored, a RAM 913 that is connected to the MPU 911 and in which a command of an application program is temporarily stored and a temporary storage area is provided, a storage 914 in which an application program, a system program, and data are stored, a bus 915 that connects the MPU 911, the ROM 912, and the like, a network card 916 for providing a connection to networks such as an internal network or an external network, a first microphone 917, a second microphone 918, and an external display screen 919. Note that the storage 914 is, for example, a hard disk, an SSD, a flash memory, or the like.

The program for causing the computer system 900 to execute the functions of the server apparatus 1, the audio processing apparatus 5, and the like may be stored in a disk 921 such as a DVD or a CD-ROM that is inserted into the disk drive 905 and be transferred to the storage 914. Alternatively, the program may be transmitted via a network to the computer 901 and stored in the storage 914. At the time of execution, the program is loaded into the RAM 913. The program may be loaded from the disk 921, or directly from a network. Furthermore, the program may be read by the computer system 900 via a removable storage medium other than the disk 921 (e.g., a DVD, a memory card, etc.).

The program does not necessarily have to include, for example, an operating system (OS) or a third party program to cause the computer 901 described in detail to execute the functions of the server apparatus 1, the audio processing apparatus 5, and the like. The program may only include a command portion to call an appropriate function or module in a controlled mode and obtain desired results. The manner in which the computer system 900 operates is well known, and thus a detailed description thereof has been omitted.

The computer system 900 described above is a server or a desktop terminal, but the terminal apparatus 2, the interpreter apparatus 4, the audio processing apparatus 5, and the like may be realized, for example, by mobile terminals such as tablet devices, smartphones, laptops, and the like. In this case, it is also possible that, for example, the keyboard 902 and the mouse 903 are replaced by a touch panel, and the disk drive 905 is replaced by a memory card slot, and the disk 921 is replaced by a memory card. Note that the description above is merely an example, and there is no limitation on the hardware configuration of the computer that realizes the server apparatus 1, the audio processing apparatus 5, and the like.

It should be noted that, in the programs, in a step of transmitting information, a step of receiving information, or the like, processing that is performed by hardware, for example, processing performed by a modem or an interface card in the transmitting step (processing that can be performed only by hardware) is not included.

Furthermore, the computer that executes this program may be a single computer, or may be multiple computers. That is to say, centralized processing may be performed, or distributed processing may be performed.

Furthermore, in the foregoing embodiments, it will be appreciated that two or more communication parts (the receiving function of the accepting unit 52, the transmitting function of the output unit 54, etc.) in one apparatus may be physically realized by one medium.

In the foregoing embodiment, each process (each function) may be realized as centralized processing using a single apparatus (system), or may be realized as distributed processing using multiple apparatuses.

The present invention is not limited to the embodiment set forth herein. Various modifications are possible within the scope of the invention.

### INDUSTRIAL APPLICABILITY

As described above, the audio processing apparatus according to the present invention has an effect that it is possible to accumulate first audio and second audio, which is audio obtained through simultaneous interpretation of the first audio, in association with each other, and thus this system is useful as an audio processing apparatus and the like.

Furthermore, the server apparatus according to the present invention has an effect that it is possible to properly set an interpretation language of each of one or more interpreters and a language of a speaker corresponding to an interpreter, and thus this system is useful as a server apparatus and the like.

1. An audio processing apparatus comprising:
a first audio accepting unit that accepts first audio of speech uttered by a first speaker of a first language;
a second audio accepting unit that accepts second audio, which is audio obtained through simultaneous interpretation of the first audio into a second language by a second speaker; and
an accumulating unit that accumulates the first audio and the second audio in association with each other.

2. The audio processing apparatus according to claim 1, further comprising an audio association processing unit that associates a first audio segment, which is part of the first audio, with a second audio segment, which is part of the second audio,
wherein the accumulating unit accumulates the first audio segment and the second audio segment associated with each other by the audio association processing unit.

3. The audio processing apparatus according to claim 2, further comprising a speech recognition unit that performs speech recognition processing on the first audio, thereby acquiring a first sentence block, which is text corresponding to the first audio, and performs speech recognition processing on the second audio, thereby acquiring a second sentence block, which is text corresponding to the second audio,
wherein the audio association processing unit includes:
a dividing part that divides the first sentence block into two or more sentences, thereby acquiring two or more first sentences, and divides the second sentence block into two or more sentences, thereby acquiring two or more second sentences;
a sentence associating part that associates one or more first sentences and one or more second sentences acquired by the dividing part, with each other; and
an audio associating part that associates one or more first audio segments corresponding to the one or more first sentences associated by the sentence associating part with one or more second audio segments corresponding to the one or more second sentences associated by the sentence associating part, and
the accumulating unit accumulates the one or more first audio segments and the one or more second audio segments associated with each other by the audio association processing unit.

4. The audio processing apparatus according to claim 3, wherein the sentence associating part includes:
a machine translation part that performs machine translation of two or more first sentences acquired by the dividing part into a second language, or performs machine translation of two or more second sentences acquired by the dividing part; and
a translation result associating part that compares a translation result of two or more first sentences machine-translated by the machine translation part and two or more second sentences acquired by the dividing part and associates one or more first sentences and one or more second sentences acquired by the dividing part, with each other, or compares a translation result of two or more second sentences machine-translated by the machine translation part and two or more first sentences acquired by the dividing part and associates one or more first sentences and one or more second sentences acquired by the dividing part, with each other.

5. The audio processing apparatus according to claim 3, wherein the sentence associating part associates one first sentence and two or more second sentences acquired by the dividing part, with each other.

6. The audio processing apparatus according to claim 5, wherein the sentence associating part detects a second sentence corresponding to each of one or more first sentences acquired by the dividing part, and associates a second sentence not associated with the first sentence, with a first sentence corresponding to a second sentence located before the second sentence, thereby associating one first sentence with two or more second sentences.

7. The audio processing apparatus according to claim 6, wherein the sentence associating part determines whether or not a second sentence is not associated with the first sentence and has a predetermined relationship with a second sentence located immediately therebefore, and, in a case of determining that the second sentence has a predetermined relationship therewith, associates the second sentence not associated with the first sentence, with a first sentence corresponding to the second sentence located before the second sentence.

8. The audio processing apparatus according to claim 3,
wherein the sentence associating part detects a second sentence associated with each of two or more first sentences acquired by the dividing part, and detects a first sentence not associated with any second sentence, and
the audio processing apparatus further comprises a missing interpretation output unit that outputs a detection result of the sentence associating part.

9. The audio processing apparatus according to claim 3, further comprising:
an evaluation acquiring unit that acquires evaluation information regarding evaluation of an interpreter who performed simultaneous interpretation, using an association result of one or more first sentences and one or more second sentences acquired by the sentence associating part; and
an evaluation output unit that outputs the evaluation information.

10. The audio processing apparatus according to claim 9, wherein the evaluation acquiring unit acquires evaluation information in which the larger the number of first sentences each associated with two or more second sentences, the higher the rating.

11. The audio processing apparatus according to claim 9, wherein the evaluation acquiring unit acquires evaluation information in which the smaller the number of first sentences not associated with any second sentence, the lower the rating.

12. The audio processing apparatus according to claim 9,
wherein the first audio and the second audio are associated with timing information for specifying timing, and
the evaluation acquiring unit acquires evaluation information in which the larger a difference between first timing information associated with a first sentence associated by the sentence associating part and second timing information associated with a second sentence associated with the first sentence, the lower the rating.

13. The audio processing apparatus according to claim 3, wherein the audio association processing unit further includes:
a timing information acquiring part that acquires two or more pieces of first timing information associated with the two or more first sentences and two or more pieces of second timing information associated with the two or more second sentences; and
a timing information associating part that associates the two or more pieces of first timing information with the two or more first sentences, and associates the two or more pieces of second timing information with the two or more second sentences.

14. A method for producing a corpus of an audio pair, realized using a first audio accepting unit, a second audio accepting unit, and an accumulating unit, comprising:
a first audio accepting step of the first audio accepting unit accepting first audio of speech uttered by a first speaker of a first language;
a second audio accepting step of the second audio accepting unit accepting second audio, which is audio obtained through simultaneous interpretation of the first audio into a second language by a second speaker; and
an accumulating step of the accumulating unit accumulating the first audio and the second audio in association with each other.

15. A non-transitory storage medium on which a program is stored, the program causing a computer to function as:
a first audio accepting unit that accepts first audio of speech uttered by a first speaker of a first language;
a second audio accepting unit that accepts second audio, which is audio obtained through simultaneous interpretation of the first audio into a second language by a second speaker; and
an accumulating unit that accumulates the first audio and the second audio in association with each other.
